(19) United States
(12) Patent Application Publication
(10) Pub. No.: US 2025/0274713 A1
(43) Pub. Date: Aug. 28, 2025

(54) DEVICE HAVING A VIBRATION APPARATUS

(71) Applicant: LG Display Co., Ltd., Seoul (KR)

(72) Inventors: Uihyeon Jeong, Paju-si (KR); Sooyoun Kim, Paju-si (KR); JounHo Lee, Paju-si (KR); YongWoo Lee, Paju-si (KR); HwaYoul Lee, Paju-si (KR); Daesu Kim, Paju-si (KR)

(73) Assignee: LG Display Co., Ltd., Seoul (KR)

(21) Appl. No.: 19/061,829

(22) Filed: Feb. 24, 2025

(30) Foreign Application Priority Data
Feb. 26, 2024 (KR) 10-2024-0027341

(51) Int. Cl. H04R 7/06; H04R 1/02; H04R 7/04; H04R 17/00

(52) U.S. Cl. CPC H04R 7/06; H04R 1/023; H04R 7/045; H04R 17/005; H04R 2499/15

(57) ABSTRACT

The present disclosure relates to a device having a vibration apparatus. According to an embodiment of the present disclosure, a device comprises: a vibration member; and a vibration apparatus configured to vibrate the vibration member. The vibration apparatus includes a vibration part having first to n-th vibration layers overlapping each other. Here, ‘n’ is a natural number greater than or equal to 2, and the first to n-th vibration layers have different thicknesses.

### CROSS-REFERENCE TO RELATED APPLICATIONS

This application claims the benefit of the Korean Patent Application No. 10-2024-0027341 filed on Feb. 26, 2024, which is hereby incorporated by reference as if fully set forth herein.

### BACKGROUND

### Technical Field

The present disclosure relates to a device having a vibration apparatus.

### Description of the Related Art

Devices such as display device require separate speakers for providing a sound. When a speaker is in a display device, the speaker occupies a space; due to this, the design and spatial arrangement of the display device are limited.

### BRIEF SUMMARY

Typically, a sound output from a speaker may travel to a rearward or a downward direction of the display device. Therefore, sound quality may be degraded due to interference between sounds reflected from a wall and the ground. For this reason, it may be difficult to transfer an accurate sound, and the immersion experience of a viewer is reduced. The inventors have recognized problems described above and have performed various experiments for implementing a vibration apparatus for enhancing the quality of a sound and a sound pressure characteristic. Therefore, through the various experiments, the inventors have developed multiple embodiments of a device with a new structure, which includes a vibration apparatus designed to enhance sound quality and sound pressure characteristics.

One or more embodiments of the present disclosure are directed to providing a device capable of generating sound by vibrating a vibration member.

One or more embodiments of the present disclosure are directed to providing a device which improves sound pressure characteristics by increasing an amplitude displacement of a vibration apparatus.

Additional features and embodiments will be set forth in part in the description that follows, and in part will become apparent from the description, or may be learned by practice of the inventive concepts provided herein. Other features and embodiments of the inventive concepts may be realized and attained by the structure particularly pointed out in the written description, or derivable therefrom, and the claims hereof as well as the appended drawings.

To achieve these and other embodiments of the inventive concepts, as embodied and broadly described herein, a device may comprise a vibration member, and a vibration apparatus configured to vibrate the vibration member, wherein the vibration apparatus includes a vibration part having first to n-th vibration layers overlapping each other, wherein ‘n’ is a natural number greater than or equal to 2, and the first to n-th vibration layers have different thicknesses.

According to one or more embodiment of the present disclosure, the device may have improved sound pressure characteristics by increasing the amplitude displacement of the vibration apparatus.

According to one or more embodiments of the present disclosure, the device may improve the middle-pitched sound band, the low-pitched sound band, and/or the middle-and-low-pitched sound band characteristics of the sound generated according to the displacement of the vibration apparatus.

According to one or more embodiments of the present disclosure, the device has improved sound pressure characteristics so that the device may be driven with low power and may have the effect of reducing power consumption.

Other systems, methods, features and embodiments will be, or will become, apparent to one with skill in the art upon review of the following figures and detailed description. It is intended that all such additional systems, methods, features and embodiments be included within this description, be within the scope of the present disclosure, and be protected by the following claims. Nothing in this section should be taken as a limitation on those claims. Further embodiments and features are discussed below in conjunction with embodiments of the disclosure.

It is to be understood that both the foregoing general description and the following detailed description of the present disclosure are exemplary and explanatory and are intended to provide further explanation of the inventive concepts as claimed.

### BRIEF DESCRIPTION OF THE SEVERAL VIEWS OF THE DRAWINGS

The accompanying drawings, which are included to provide a further understanding of the disclosure and are incorporated in and constitute a part of this disclosure, illustrate embodiments and examples of the disclosure and together with the description serve to explain principles of the disclosure.

FIG. 1 is a diagram illustrating a device according to an embodiment of the present disclosure.

FIG. 2 is a diagram illustrating a device according to another embodiment of the present disclosure.

FIG. 3 is a diagram illustrating a device according to another embodiment of the present disclosure.

FIG. 4 is a diagram illustrating a device according to another embodiment of the present disclosure.

FIG. 5 is a diagram illustrating a device according to another embodiment of the present disclosure.

FIG. 6 is a diagram illustrating a device according to another embodiment of the present disclosure.

FIG. 7 is a cross-sectional view taken along line I-I′ of FIG. 6.

### DETAILED DESCRIPTION

Reference will now be made in detail to embodiments of the present disclosure, examples of which may be illustrated in the accompanying drawings. In the following description, when a detailed description of well-known functions or configurations is determined to unnecessarily obscure a gist of the inventive concept, the detailed description thereof will be omitted. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations are selected only for convenience of writing the specification and may be thus different from those used in actual products.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Like reference numerals refer to like elements throughout. In the following description, when the detailed description of the relevant known function or configuration is determined to unnecessarily obscure the important point of the present disclosure, the detailed description will be omitted. When “comprise,” “have,” and “include” are used in the present specification, another part may be added unless “only” is used. The terms of a singular form may include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts may be disposed between the two parts unless a more limiting term, such as “just” or “direct(ly)” is used.

In describing a time relationship, for example, when the temporal order is described as, for example, “after,” “subsequent,” “next,” and “before,” a case that is not continuous may be included unless a more limiting term, such as “just,” “immediate(ly),” or “direct(ly)” is used.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc., may be used. These terms are intended to distinguish the corresponding elements from the other elements, and essence, order, or number of the corresponding elements should not be limited by these terms. With respect to the expression that an element or layer is “connected,” “coupled,” or “adhered” to another element or layer, the element or layer can not only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

Hereinafter, embodiments of the present disclosure will be described in detail with reference to the accompanying drawings. For convenience of description, a scale of each of elements illustrated in the accompanying drawings differs from a real scale, and thus, is not limited to a scale illustrated in the drawings.

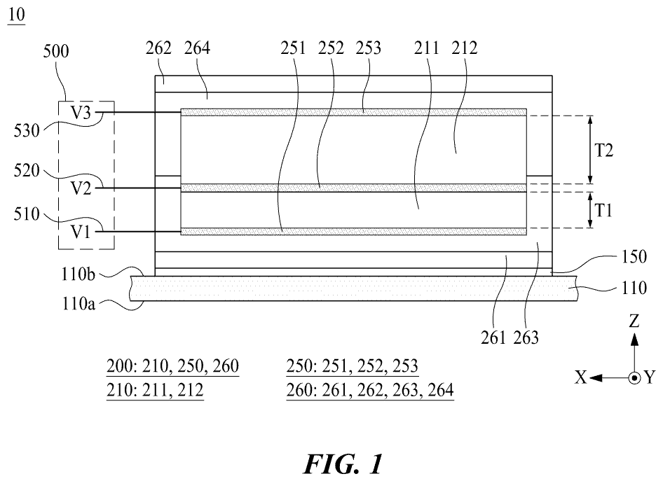

FIG. 1 is a diagram illustrating a device according to an embodiment of the present disclosure.

Referring to FIG. 1, a device 10 according to an embodiment of the present disclosure may include a vibration member 110 and a vibration apparatus 200.

A vibration member 110 may generate vibration or output sound (or sound wave or sound pressure) according to the driving (or vibration) of vibration apparatus 200. The vibration member 110 may vibrate according to vibration (or displacement) of the vibration apparatus 200. For example, the vibration member 110 may generate at least one of vibration and sound according to the driving of the vibration apparatus 200.

The vibration member 110 according to an example embodiment of the present disclosure may be a display panel including a display area (or a screen) having a plurality of pixels which implement a black/white or color image. Thus, the vibration member 110 may generate one or more of a vibration and a sound based on driving of the one or more vibration apparatuses 200. For example, the vibration member 110 may vibrate based on a vibration of the vibration apparatus 200 while a display area is displaying an image, and thus, may generate or output a sound synchronized with the image displayed on the display area. For example, the vibration member 110 according to an example embodiment of the present disclosure may be a vibration object, a display member, a display panel, a signage panel, a passive vibration plate, a front cover, a front member, a vibration panel, a sound panel, a passive vibration panel, a sound output plate, a sound vibration plate, or a video screen, but embodiments of the present disclosure are not limited thereto.

The vibration member 110 according to another example embodiment of the present disclosure may have a material characteristic suitable for outputting a sound based on a vibration of each of the one or more vibration apparatuses 200. The vibration member 110 may include a metallic material or a non-metallic material (or a composite non-metallic material), but the embodiments of the present disclosure are not limited thereto. For example, the vibration member 110 may include one or more materials of metal, plastic, paper, wood, fiber, cloth, leather, glass, carbon, and mirror. For example, the paper may be a cone paper for speakers. For example, the cone paper may be pulp or foam plastic, but embodiments of the present disclosure are not limited thereto.

The vibration member 110 according to another example embodiment of the present disclosure may include a display panel including a pixel displaying an image, or may include a non-display panel. For example, the vibration member 110 may include one or more of a display panel including a pixel configured to display an image, a screen panel on which an image is to be projected from a display device, a lighting panel, a light emitting diode lighting panel, an organic light emitting lighting panel, an inorganic light emitting lighting panel, a signage panel, a vehicular interior material, a vehicular exterior material, a vehicular glass window, a vehicular seat interior material, a ceiling material of a building, an interior material of a building, a glass window of a building, an interior material of an aircraft, a glass window of an aircraft, and mirror, but embodiments of the present disclosure are not limited thereto. For example, the non-display panel may be a light emitting diode lighting panel (or device), an organic light emitting diode lighting panel (or device), or an inorganic light emitting diode lighting panel (or device), but embodiments of the present disclosure are not limited thereto.

According to an embodiment of the present disclosure, a device 10 may further include a connection member 150 disposed between the vibration member 110 and the vibration apparatus 200. The connection member 150 may be disposed between the vibration member 110 and the vibration apparatus 200 and may be configured to connect or couple the vibration apparatus 200 to the vibration member 110. For example, the vibration apparatus 200 may be connected or coupled to the vibration member 110 via the connection member 150 so that the vibration apparatus 200 may be supported or disposed on the vibration member 110.

According to an embodiment of the present disclosure, the connection member 150 may include a material including an adhesive layer which is good in adhesive force or attaching force with respect to the first surface 100b of the vibration member 110 or the display panel and each of the one or more vibration apparatuses 200. For example, the connection member 150 may include a foam pad, a double-sided tape, an adhesive, or the like, but embodiments of the present disclosure are not limited thereto. For example, an adhesive layer of the connection member 150 may include epoxy, acryl, silicone, or urethane, but embodiments of the present disclosure are not limited thereto. For example, the adhesive layer of the connection member 150 may include an acryl-based material, having a characteristic where an adhesive force is relatively good and hardness is high, comparted to a urethane-based material. Accordingly, a vibration of each of the vibration apparatuses 200 may be well transferred to the vibration member 110.

An adhesive layer of the connection member 150 may further include an additive such as a tackifier, a wax component, or an antioxidant. The additive may prevent a separation (or peeling) of the connection member 150 from the vibration member 110 by the vibration of the vibration apparatus 200. For example, the tackifier may be a rosin derivative or the like, and the wax component may be paraffin wax or the like. For example, the antioxidant may be a phenolic antioxidant such as thioester, but not limited thereto.

According to another embodiment of the present disclosure, the connection member 150 may further include a hollow portion prepared between the vibration member 110 and the vibration apparatus 200. The hollow portion of the connection member 150 may provide an air gap between the vibration member 110 and the vibration apparatus 200. Since the sound wave (or sound pressure) generated according to the vibration of the vibration apparatus 200 is not dispersed by the connection member 150 but concentrated on the vibration member 110, the loss of vibration caused by the connection member 150 may be minimized so that it is possible to improve the sound pressure characteristics of the sound generated according to the vibration of the vibration member 110.

According to the embodiment of the present disclosure, the vibration apparatus 200 may be configured to vibrate the vibration member 110. The vibration apparatus 200 may include a vibration part 210 having first to n-th vibration layers 211 and 212 overlapping each other. For example, ‘n’ may be a natural number of 2 or more. For example, the first to n-th vibration layers 211 and 212 may have different thicknesses. For example, the thickness T1 of the first vibration layer 211 may be smaller than the thickness T2 of the n-th vibration layer 212, but embodiments of the present disclosure are not limited thereto. For example, the thickness T1 of the first vibration layer 211 adjacent to the vibration member 110 may be smaller than the thickness T2 of the second vibration layer 212, but embodiments of the present disclosure are not limited thereto. For example, the first to n-th vibration layers 211 and 212 may be displaced in the same direction.

The device 10 according to the present disclosure may include an asymmetric vibration apparatus 200 having different thicknesses of the vibration layer. For example, the first vibration layer 211 may be an active layer, but embodiments of the present disclosure are not limited thereto. For example, the second vibration layer 212 may be a support layer, but embodiments of the present disclosure are not limited thereto.

Referring to FIG. 1, in the device 10 according to the embodiment of the present disclosure, ‘n’ may be 2. For example, the vibration part 210 may include the first vibration layer 211 and the second vibration layer 212. The first vibration layer 211 may be formed between the vibration member 110 and the second vibration layer 212. The first vibration layer 211 may be formed on a first surface 110b of the vibration member 110. For example, the first vibration layer 211 may be formed between the first surface 110b of the vibration member 110/second surface 110a which is different from the first surface 110b of the vibration member 110 and the second vibration layer 212. The second vibration layer 212 may be formed on the first vibration layer 211. The first vibration layer 211 and the second vibration layer 212 may be overlapped or may be stacked to be displaced (or driven) in the same direction. However, embodiments of the present disclosure are not necessarily limited thereto.

According to the embodiment of the present disclosure, the first vibration layer 211 and the second vibration layer 212 may have substantially the same length and width, but not limited thereto. For example, the first vibration layer 211 and the second vibration layer 212 may have substantially the same length and width within an error range of a manufacturing process.

For example, when the lengths and widths of the first vibration layer 211 and the second vibration layer 212 are different from each other, the displacement direction and the amplitude displacement of each of the first vibration layer 211 and the second vibration layer 212 do not coincide with each other so that at least one of the first vibration layer 211 and the second vibration layer 212 may be difficult to maximize the amplitude displacement of the vibration apparatus 200. For example, when at least one of the first vibration layer 211 and the second vibration layer 212 has the different length and width out of an error range of the manufacturing process, the displacement direction and the amplitude displacement of each of the first vibration layer 211 and the second vibration layer 212 do not coincide with each other, whereby it is difficult to maximize the amplitude displacement of the vibration apparatus 200. For example, in case of that the lengths and widths of the first vibration layer 211 and the second vibration layer 212 are different from each other, when at least one of the first vibration layer 211 and the second vibration layer 212 is displaced in another direction, the displacement directions of the first vibration layer 211 and the second vibration layer 212 do not coincide with each other, whereby it is difficult to maximize the amplitude displacement of the vibration apparatus 200.

In the device 10 according to the embodiment of the present disclosure, since the first vibration layer 211 and the second vibration layer 212 have substantially the same length and width, the displacement direction and the amplitude displacement of the first vibration layer 211 and the second vibration layer 212 may coincide with each other, and the amplitude displacement of the vibration apparatus 200 may be maximized.

According to the embodiment of the present disclosure, the first vibration layer 211 and the second vibration layer 212 may have different thicknesses, but embodiments of the present disclosure are not limited thereto. For example, the thickness T1 of the first vibration layer 211 adjacent to the vibration member 110 in the first vibration layer 211 and the second vibration layer 212 may be smaller than the thickness T2 of the second vibration layer 212, but embodiments of the present disclosure are not limited thereto. For example, the thickness T1 of the first vibration layer 211 may be 50% or less as compared to the thickness T2 of the second vibration layer 212, but embodiments of the present disclosure are not limited thereto. According to the embodiment of the present disclosure, when the thickness of the vibration member 110 is 600 μm, the thickness T1 of the first vibration layer 211 may be in a range of 280 μm to 300 μm, and the thickness T2 of the second vibration layer 212 may be in a range of 750 μm to 800 μm. However, embodiments of the present disclosure are not necessarily limited thereto.

According to the embodiment of the present disclosure, a voltage applied to the first vibration layer 211 may be the same as a voltage applied to the second vibration layer 212, but embodiments of the present disclosure are not limited thereto. In the vibration apparatus 200 according to the embodiment of the present disclosure, the thickness T1 of the first vibration layer 211 may be less than the thickness T2 of the second vibration layer 212, and the same voltage may be applied to the first vibration layer 211 and the second vibration layer 212. Accordingly, the device 10 according to the embodiment of the present disclosure may supply a higher electric field to the first vibration layer 211 adjacent to the vibration member 110 with the same power consumption. For example, when a driving voltage of 10V is applied to each of the first vibration layer 211 and the second vibration layer 212, an electric field of the first vibration layer 211 may be about 0.333 k V/cm, and an electric field of the second vibration layer 212 may be about 0.128 k V/cm. For example, as the value of the electric field applied to the vibration layer increases, the vibration apparatus 200 may have the larger amplitude displacement.

Accordingly, since the amplitude displacement of the first vibration layer 211 adjacent to the vibration member 110 is greater than that of the second vibration layer 212, the vibration apparatus 200 according to the embodiment of the present disclosure may have the improved sound pressure characteristics by increasing the amplitude displacement of the vibration apparatus 200.

The vibration part 210 according to the embodiment of the present disclosure may include a piezoelectric material. The vibration part 210 may be referred to as a vibration layer, a piezoelectric layer, a piezoelectric material layer, an electroactive layer, a piezoelectric vibration part, a piezoelectric material part, an electroactive part, an inorganic material layer, or an inorganic material part, but not limited thereto.

The vibration part 210 may be formed of a transparent, semi-transparent, or opaque piezoelectric material, whereby it may be transparent, semi-transparent, or opaque.

The vibration part 210 may be made of a ceramic-based material capable of realizing a relatively high vibration or a piezoelectric ceramic material having a perovskite-based crystal structure. The perovskite-based crystal structure may have a piezoelectric and/or reverse piezoelectric effect and may have a plate-shaped structure having orientation. The perovskite-based crystal structure may be represented by a chemical formula of ABO₃, wherein the A site may be formed of a divalent metal element, and the B site may be formed of a tetravalent metal element. As an example, in a chemical formula of ABO₃, the A site and the B site may be cations, and O may be anions. For example, the vibration part 210 may include at least any one of PbTiO₃, PbZrO₃, PbZrTiO₃, BaTiO₃, and SrTiO₃, but embodiments of the present disclosure are not limited thereto.

The vibration part 210 according to the embodiment of the present disclosure may include at least one of lead Pb, zirconium Zr, titanium Ti, zinc Zn, nickel Ni, and niobium Nb, but not limited thereto.

The vibration part 210 according to another embodiment of the present disclosure may include a lead zirconate titanate PZT-based material including lead Pb, zirconium Zr, and titanium Ti, or a lead zirconate nickel niobate PZNN-based material including lead Pb, zirconium Zr, nickel Ni, and niobium Nb, but embodiments of the present disclosure are not limited thereto. For example, the vibration part 210 may include at least one selected from the group of materials not including lead Pb, for example, at least one of CaTiO₃, BaTiO₃, and SrTiO₃, but embodiments of the present disclosure are not limited thereto.

In the vibration part 210 according to another embodiment of the present disclosure, a piezoelectric deformation coefficient d₃₃ according to the thickness direction Z may be 1,000 pC/N or more. As it has the high piezoelectric deformation coefficient d₃₃, the vibration apparatus 200 may be applied to a display panel having a large size, or may have sufficient vibration characteristics or piezoelectric characteristics. For example, the vibration part 210 may include a PZT-based material PbZrTiO₃ as a main component, a softener dopant material Pb doped in A site, and a relaxor ferroelectric material ZrTi doped in B site.

The softener dopant material may improve the piezoelectric and dielectric characteristics of the vibration part 210. For example, the softener dopant material may increase the piezoelectric deformation coefficient d₃₃ of the vibration part 210. When the softener dopant material consists of +1 elements, the piezoelectric and dielectric characteristics may be reduced. For example, when the softener dopant material is composed of potassium K and rubidium Rb, the piezoelectric and dielectric characteristics may be reduced. Accordingly, in order to improve the piezoelectric and dielectric characteristics through various experiments, it is recognized that the softener dopant material is composed of +2 to +3 elements. The softener dopant material according to the embodiment of the present disclosure may include +2 to +3 elements. As a morphotropic phase boundary MPB is formed by including the softener dopant material in the PZT-based material PbZrTiO₃, the piezoelectric characteristics and the dielectric characteristics may be improved. For example, the softener dopant material may include strontium Sr, barium Ba, lanthanum La, neodymium Nd, calcium Ca, yttrium Y, erbium Er, or ytterbium Yb, but embodiments of the present disclosure are not limited thereto. For example, ions Sr²⁺, Ba²⁺, La²⁺, Nb⁵⁺, Ca²⁺, Y³⁺, Er³⁺, and Yb³⁺ of the softener dopant material doped in the PZT-based material PbZrTiO₃ replace some of the lead Pb in the PZT-based material PbZrTiO₃ and a replacement amount may be about 0.01 mol % to about 0.2 mol %. For example, when the replacement amount is less than 2 mol % or greater than 20 mol %, the perovskite crystal structure may be broken, whereby the electrical coupling coefficient k_{P} and the piezoelectric deformation coefficient d₃₃ may decrease. When the softener dopant material is replaced, the morphotropic phase boundary MPB may be formed, and the high piezoelectric and dielectric characteristics may be realized in the morphotropic phase boundary MPB, so that it is possible to implement the vibration apparatus having the high piezoelectric characteristics and dielectric characteristics.

For example, the relaxor ferroelectric material doped in the PZT-based material PbZrTiO₃ may improve the electrical deformation characteristics of the vibration part 210. For example, the relaxor ferroelectric material may include a lead magnesium niobate PMN-based material or a lead nickel niobate PNN-based material, but embodiments of the present disclosure are not limited thereto. The PMN-based material may include lead Pb, magnesium Mg, and niobium Nb, and may be, for example, Pb(Mg, Nb)O₃. The PNN-based material may include lead Pb, nickel Ni, and niobium Nb, for example, Pb(Ni, Nb)O₃. For example, the relaxor ferroelectric material doped in the PZT-based material PbZrTiO₃ may replace a portion in each of zirconium Zr and titanium Ti in the PZT-based material PbZrTiO₃, and a replacement amount may be 5 mol % to 25 mol %. For example, when the replacement amount is less than 5 mol % or greater than 25 mol %, the perovskite crystal structure is broken, whereby the electrical coupling coefficient k_{P} and the piezoelectric deformation coefficient d₃₃ may decrease.

For example, the vibration part 210 may further include a donor material ZrTi doped in the B site of the PZT-based material PbZrTiO₃ in order to further improve the piezoelectric coefficient. For example, the donor material doped in the B site may include +4 to +6 elements, but embodiments of the present disclosure are not limited thereto. For example, the donor material doped in the B site may include tellurium Te, germanium Ge, uranium U, bismuth Bi, niobium Nb, tantalum Ta, antimony Sb, or tungsten W, but embodiments of the present disclosure are not limited thereto.

For example, the vibration part 210 may have the piezoelectric deformation coefficient d₃₃ of 1,000 pC/N or more so that it is possible to implement the vibration apparatus having the improved vibration characteristics. For example, the vibration apparatus having the improved vibration characteristics may be implemented in a large-sized device or a display device.

For example, the vibration part 210 may be configured in a circular shape, an elliptical shape, or a polygonal shape, but not limited thereto.

According to the embodiment of the present disclosure, the vibration apparatus 200 may further include a plurality of electrode layers 250. Each of the plurality of electrode layers 250 may be configured between the uppermost surface of the vibration layer, the lowermost surface of the vibration layer, and the plurality of vibration parts 210.

According to the embodiment of the present disclosure, the plurality of electrode layers 250 may include first to third electrode layers 251, 252, and 253.

The first electrode layer 251 may be electrically connected to the first surface (or lower surface) of the first vibration layer 211. The first electrode layer 251 may be configured between the first surface (or lower surface) of the first vibration layer 211 and the vibration member 110. The first electrode layer 251 may be electrically connected to a first signal line 510 of a vibration driving circuit 500. The first electrode layer 251 may be displaced (or vibrated) by a first vibration driving signal V1 applied from the first signal line 510.

The second electrode layer 252 may be formed between the second surface (or upper surface) of the first vibration layer 211 and the first surface (or lower surface) of the second vibration layer 212. The second electrode layer 252 may be electrically connected to the second surface (or upper surface) of the first vibration layer 211 opposite to the first surface (or lower surface) of the first vibration layer 211 and the first surface (or lower surface) of the second vibration layer 212. For example, the second electrode layer 252 may be a common electrode formed between the first vibration layer 211 and the second vibration layer 212. The second electrode layer 252 may be electrically connected to a second signal line 520 of the vibration driving circuit 500. The second electrode layer 252 may be displaced (or vibrated) by a second vibration driving signal V2 applied from the second signal line 520.

The third electrode layer 253 may be electrically connected to the second surface (or upper surface) of the second vibration layer 212 opposite to the first surface (or lower surface) of the second vibration layer 212. The third electrode layer 253 may be electrically connected to a third signal line 530 of the vibration driving circuit 500. The third electrode layer 253 may be displaced (or vibrated) by a third vibration driving signal V3 applied from the third signal line 530.

According to the embodiment of the present disclosure, each of the first and second vibration layers 211 and 212 may be polarized by a constant voltage applied to the first to third electrode layers 251, 252, and 253 in a constant temperature atmosphere or a temperature atmosphere which is changed from a high temperature to a room temperature. For example, the first vibration layer 211 may vibrate by alternately repeating contraction and/or expansion due to a reverse piezoelectric effect according to the vibration driving signals V1 and V2 applied to the first electrode layer 251 and the second electrode layer 252. For example, the first vibration layer 211 may vibrate by the vibration d₃₃ in the vertical direction and the vibration d31 in the plane direction (or horizontal direction) by the first electrode layer 251 and the second electrode layer 252. For example, displacement of the vibration apparatus 200 or displacement of the vibration member 110 may be increased by the contraction and expansion in the plane direction of the first vibration layer 211, thereby further improving the vibration characteristics of the vibration apparatus 200 or the vibration member 110.

For example, the second vibration layer 212 may vibrate by alternately repeating the contraction and/or expansion due to the reverse piezoelectric effect according to the vibration driving signals V2 and V3 applied to the second electrode layer 252 and the third electrode layer 253. For example, the second vibration layer 212 may vibrate by the vibration d₃₃ in the vertical direction and the vibration d31 in the plane direction (or horizontal direction) by the second electrode layer 252 and the third electrode layer 253. For example, displacement of the vibration apparatus 200 or displacement of the vibration member 110 may be increased by the contraction and/or expansion in the plane direction of the second vibration layer 212, thereby further improving the vibration characteristics of the vibration apparatus 200 or the vibration member 110.

According to the embodiment of the present disclosure, the first to third electrode layers 251, 252, and 253 may have the same size as or a smaller size than the first and second vibration layers 211 and 212, but embodiments of the present disclosure are not limited thereto. For example, the first to the third electrode layers 251, 252, 253 may include a transparent conductive material, a semitransparent conductive material, or an opaque conductive material. For example, the transparent or semitransparent conductive material may include one or more of indium tin oxide (ITO) or indium zinc oxide (IZO), but embodiments of the present disclosure are not limited thereto. The opaque conductive material may include one or more of gold (Au), silver (Ag), platinum (Pt), palladium (Pd), molybdenum (Mo), magnesium (Mg), carbon, or glass frit-including silver (Ag), or an alloy thereof, but embodiments of the present disclosure are not limited thereto. For example, the first to the third electrode layers 251, 252, 253 may include silver (Ag) having a low resistivity, to enhance an electrical characteristic and/or a vibration characteristic of the first and the second vibration layers 211 and 212. For example, carbon may be a carbon material including carbon black, ketjen black, carbon nanotube, and graphite, but embodiments of the present disclosure are not limited thereto.

According to the embodiment of the present disclosure, since the device 10 includes the first vibration layer 211, the second vibration layer 212, and the plurality of electrode layers 250 stacked or disposed, the volume and thickness of the vibration apparatus 200 may be reduced.

The vibration apparatus 200 according to the embodiment of the present disclosure may further include a cover member 260.

The cover member 260 may be configured on at least one of the first surface and the second surface of the vibration part 210. For example, the cover member 260 may be configured to cover at least one of the first surface and the second surface of the vibration part 210. The cover member 260 may be configured to protect at least one of the first surface and the second surface of the vibration part 210. For example, the first surface of the vibration part 210 may be a rear surface, a lower surface, or a bottom surface. For example, the second surface of the vibration part 210 may be an upper surface or a top surface which is opposite to the first surface. The cover member 260 may be configured to protect at least one of the first electrode layer 251 and the third electrode layer 253. For example, the cover member 260 may be configured to protect at least one of the first surface (or lower surface) of the first electrode layer 251 and the second surface (or upper surface) of the third electrode layer 253.

The cover member 260 according to the embodiment of the present disclosure may include a first cover member 261.

The first cover member 261 may be disposed on the first surface (or lower surface) of the vibration part 210 and the first surface (or lower surface) of the first electrode layer 251. The first cover member 261 may be configured in the first vibration layer 211. For example, the first cover member 261 may be configured to cover the first vibration layer 211. The first cover member 261 may be configured in the first electrode layer 251. For example, the first cover member 261 may be configured to cover the first electrode layer 251. For example, the first cover member 261 may be configured to have a larger size than the vibration part 210 and the electrode layer 250, but embodiments of the present disclosure are not limited thereto. The first cover member 261 may be configured to protect the vibration part 210 and the first surface (or lower surface) of the first electrode layer 251.

The first cover member 261 according to the embodiment of the present disclosure may include an adhesive layer. For example, the first cover member 261 may include a base film and an adhesive layer disposed on the base film and connected to or coupled to the first surface of the vibration part 210. For example, the adhesive layer may include an electrical insulating material capable of compressing and restoring while having adhesiveness, but embodiments of the present disclosure are not limited thereto.

The first cover member 261 according to another embodiment of the present disclosure may be connected to or coupled to the first surface (or lower surface) of the first electrode layer 251 by the medium of the first adhesive layer 263. For example, the first cover member 261 may be connected to or coupled to the first electrode layer 251 by the medium of the first adhesive layer 263. For example, the first cover member 261 may be connected or coupled to the first electrode layer 251 by a film laminating process using the first adhesive layer 263.

The first adhesive layer 263 may be disposed on the first surface (or lower surface) of the vibration part 210. The first adhesive layer 263 may be formed on the first electrode layer 251. For example, the first adhesive layer 263 may be configured to cover the first electrode layer 251. The first adhesive layer 263 may be configured to protect the first surface (or lower surface) of the first vibration layer 211 and the first electrode layer 251. The first adhesive layer 263 may be configured to surround the entire first surface of the vibration part 210 and a portion of the side surface of the vibration part 210. The first adhesive layer 263 may surround the entire first surface of the first electrode layer 251 and the entire side surface of the first electrode layer 251. For example, the first adhesive layer 263 may be a protective layer or a protective member, but embodiments of the present disclosure are not limited thereto.

The cover member 260 according to the embodiment of the present disclosure may further include a second adhesive layer 264.

The second adhesive layer 264 may be disposed on the second surface (or upper surface) of the vibration part 210. The second adhesive layer 264 may be formed on the third electrode layer 253. For example, the second adhesive layer 264 may be configured to cover the third electrode layer 253. The second adhesive layer 264 may be configured to protect the second surface (or upper surface) of the second vibration layer 212 and the third electrode layer 253. The second adhesive layer 264 may be configured to surround the entire second surface of the vibration part 210 and a portion of the side surface of the vibration part 210. The second adhesive layer 264 may be configured to surround the entire second surface of the second vibration layer 212 and a portion of the side surface of the second vibration layer 212. For example, the second adhesive layer 264 may be a protective layer or a protective member, but embodiments of the present disclosure are not limited thereto.

According to the embodiment of the present disclosure, the first adhesive layer 263 and the second adhesive layer 264 may surround or completely surround the vibration part 210 and the electrode layer 250. The first adhesive layer 263 and the second adhesive layer 264 may be configured to cover or surround all surfaces of the vibration part 210 and the electrode layer 250. For example, the vibration part 210 and the electrode layer 250 may be inserted (or accommodated) or buried (or embedded) in the inside of the adhesive layer including the first adhesive layer 263 and the second adhesive layer 264.

The cover member 260 according to the embodiment of the present disclosure may further include a second cover member 262, but embodiments of the present disclosure are not limited thereto. The second cover member 262 may be disposed on the second surface (or upper surface) of the second vibration layer 212. The second cover member 262 may be disposed on the second surface (or upper surface) of the third electrode layer 253. The second cover member 262 may be formed on the second vibration layer 212 and the third electrode layer 253. For example, the second cover member 262 may be configured to cover the second vibration layer 212 and the third electrode layer 253. For example, the second cover member 262 may be configured to have a larger size than the vibration part 210 and the electrode layer 250 and may be configured to have the same size as the first cover member 261, but embodiments of the present disclosure are not limited thereto. The second cover member 262 may be configured to protect the second surface (or upper surface) of the second vibration layer 212 and the third electrode layer 253.

According to the embodiment of the present disclosure, the first cover member 261 and the second cover member 262 may include the same or different materials. For example, each of the first cover member 261 and the second cover member 262 may be a polyimide film, polyethylene naphthalate, or a polyethylene terephthalate film, but embodiments of the present disclosure are not limited thereto. For example, each of the first cover member 261 and the second cover member 262 may be formed or coated with a non-conductive material, but the embodiments of the present disclosure are not limited thereto.

The second cover member 262 may be connected or coupled to the second surface of the second vibration layer 212 or the third electrode layer 253 through the second adhesive layer 264. For example, the second cover member 262 may be connected or coupled to the second surface of the second vibration layer 212 or the third electrode layer 253 by a film laminating process using the second adhesive layer 264, but embodiments of the present disclosure are not limited thereto.

The vibration part 210 and the electrode layer 250 may be disposed or inserted (or accommodated) between the first cover member 261 and the second cover member 262. For example, the vibration part 210 and the electrode layer 250 may be inserted (or accommodated) or buried (or embedded) in the inside of the adhesive layer including the first adhesive layer 263 and the second adhesive layer 264, but embodiments of the present disclosure are not limited thereto.

According to the embodiment of the present disclosure, each of the first adhesive layer 263 and the second adhesive layer 264 may include an electrical insulating material capable of compression and restoration while having adhesiveness. For example, each of the first adhesive layer 263 and the second adhesive layer 264 may include epoxy resin, acrylic resin, silicone resin, urethane resin, pressure sensitive adhesive PSA, optically clear adhesive OCA, or optically cleared resin OCR, but embodiments of the present disclosure are not limited thereto.

The first adhesive layer 263 and the second adhesive layer 264 may be provided between the first cover member 261 and the second cover member 262 and may be configured to surround the vibration part 210 and the electrode layer 250. For example, at least one of the first adhesive layer 263 and the second adhesive layer 264 may be configured to surround the vibration part 210 and the electrode layer 250.

According to the embodiment of the present disclosure, the device 10 may further include the vibration driving circuit 500. The vibration driving circuit 500 may be electrically connected to the vibration apparatus 200, may generate the vibration driving signal based on sound source, and may supply the vibration driving signal to the vibration apparatus 200, to thereby vibrate or displace the vibration apparatus 200.

For example, the vibration driving circuit (or sound processing circuit) may generate the vibration driving signal of AC type including the first to third vibration driving signals V1 to V3 based on the sound source. The first vibration driving signal V1 may be any one of a positive (+) vibration driving signal and a negative (−) vibration driving signal, the second vibration driving signal V2 may be any one of a positive (+) vibration driving signal and a negative (−) vibration driving signal, and the third vibration driving signal V3 may be any one of a positive (+) vibration driving signal and a negative (−) vibration driving signal.

The vibration driving circuit 500 according to the embodiment of the present disclosure may include the plurality of signal lines 510, 520, and 530 respectively connected to the plurality of electrode layers 250 constituting the vibration apparatus 200. For example, the vibration driving circuit 500 may include the first to third signal lines 510, 520, and 530 respectively connected to the first to third electrode layers 251, 252, and 253. According to the embodiment of the present disclosure, the first signal line 510 may be electrically connected to the first electrode layer 251 to supply the first vibration driving signal V1 to the first electrode layer 251. For example, the second signal line 520 may be electrically connected to the second electrode layer 252 to supply signal line 530 may be electrically connected to the third electrode layer 253 to supply the third vibration driving signal V3 to the third electrode layer 253.

According to the embodiment of the present disclosure, the first vibration driving signal V1 and the second vibration driving signal V2 may be different driving signals, and the first vibration driving signal V1 and the third vibration driving signal V3 may be the same driving signal. For example, when the first vibration driving signal V1 and the third vibration driving signal V3 are positive (+) driving signals, the second vibration driving signal V2 may be a negative (−) driving signal. However, embodiments of the present disclosure are not necessarily limited thereto. According to the embodiment of the present disclosure, the first vibration layer 211 may be driven by the first vibration driving signal V1 and the second vibration driving signal V2, and the second vibration layer 212 may be driven by the second vibration driving signal V2 and the third vibration driving signal V3.

In the device 10 according to an embodiment of the present disclosure, the thickness T1 of the first vibration layer 211 adjacent to the vibration member 110 is smaller than the thickness T2 of the second vibration layer 212, so that the vibration displacement d31 in the plane direction (or horizontal direction) of the first vibration layer 211 may be increased. Accordingly, it is possible to maximize the amplitude displacement of the vibration apparatus 200 and the vibration member 110.

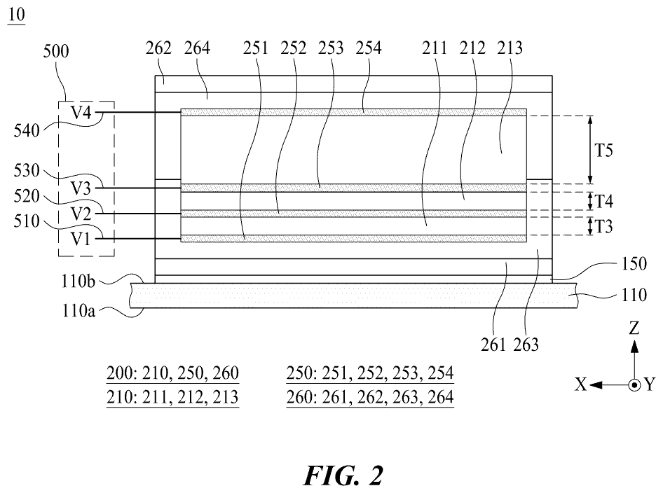

FIG. 2 is a diagram illustrating a device according to another embodiment of the present disclosure. In another embodiment of the present disclosure, configurations of a vibration layer and an electrode layer are changed, and the other components except the vibration layer and the electrode layer may be substantially the same as those of the embodiment of the present disclosure described with reference to FIG. 1. Accordingly, hereinafter, the same configuration will be briefly described or omitted, and the vibration layer, the electrode layer, and configuration related thereto will be described as follows.

Referring to FIG. 2, in a device 10 according to another embodiment of the present disclosure, ‘n’ may be 3. For example, a vibration part 210 may include a first vibration layer 211 to a third vibration layer 213. The first vibration layer 211 may be formed between a vibration member 110 and the second vibration layer 212. The second vibration layer 212 may be formed between the first vibration layer 211 and the third vibration layer 213. The third vibration layer 213 may be formed on the second vibration layer 212. The first vibration layer 211 to the third vibration layer 213 may be overlapped or be stacked to be displaced (or driven) in the same direction.

According to another embodiment of the present disclosure, the first vibration layer 211 to the third vibration layer 213 may have substantially the same length and width, but not limited thereto. For example, the first to third vibration layers 211 to 213 may have substantially the same length and width within an error range of a manufacturing process, but not limited thereto. The lengths and widths of the first vibration layer 211 to the third vibration layer 213 may be substantially the same as those of the first vibration layer 211 and the second vibration layer 212 described with reference to FIG. 1.

According to another embodiment of the present disclosure, the first vibration layer 211 and the second vibration layer 212 may have the same thickness, but embodiments of the present disclosure are not limited thereto. For example, the thickness T3 of the first vibration layer 211 may be the same as the thickness T4 of the second vibration layer 212, but embodiments of the present disclosure are not limited thereto. For example, the sum ‘T3+T4’ of the thickness T3 of the first vibration layer 211 and the thickness T4 of the second vibration layer 212 may be substantially the same as the thickness T1 of the first vibration layer 211 described with reference to FIG. 1. However, embodiments of the present disclosure are not limited thereto.

According to another embodiment of the present disclosure, the first vibration layer 211 and the third vibration layer 213 may have different thicknesses, but embodiments of the present disclosure are not limited thereto. The thickness T3 of the first vibration layer 211 and the thickness T5 of the third vibration layer 213 may be different from each other, but embodiments of the present disclosure are not limited thereto. The thickness T3 of the first vibration layer 211 may be smaller than the thickness T5 of the third vibration layer 213, but embodiments of the present disclosure are not limited thereto. The second vibration layer 212 and the third vibration layer 213 may have different thicknesses, but embodiments of the present disclosure are not limited thereto. The thickness T4 of the second vibration layer 212 may be different from the thickness T5 of the third vibration layer 213, but embodiments of the present disclosure are not limited thereto. The thickness T4 of the second vibration layer 212 may be smaller than the thickness T5 of the third vibration layer 213, but embodiments of the present disclosure are not limited thereto. For example, the sum ‘T3+T4’ of the thickness T3 of the first vibration layer 211 and the thickness T4 of the second vibration layer 212 may be smaller than the thickness T5 of the third vibration layer 213, but embodiments of the present disclosure are not limited thereto. For example, the thickness T5 of the third vibration layer 213 may be substantially the same as the thickness T2 of the second vibration layer 212 described with reference to FIG. 1. However, embodiments of the present disclosure are not limited thereto.

According to another embodiment of the present disclosure, since the thickness T3 of the first vibration layer 211 is different from the thickness T5 of the third vibration layer 213, the second vibration layer 212 may be configured to solve the problem that the vibration behaviors of the first vibration layer 211 and the third vibration layer 213 do not match. The second vibration layer 212 may be formed between the first vibration layer 211 and the third vibration layer 213. For example, the first vibration layer 211 may be an active layer, but embodiments of the present disclosure are not limited thereto. For example, the second vibration layer 212 may be a buffer layer, but embodiments of the present disclosure are not limited thereto. Since a large vibration displacement may not occur in the vibration member 110 having rigidity, the third vibration layer 213 capable of generating sufficient vibration displacement may be formed. For example, the third vibration layer 213 may be a support layer, but embodiments of the present disclosure are not limited thereto.

According to another embodiment of the present disclosure, since the thickness T3 of the first vibration layer 211 and the thickness T4 of the second vibration layer 212 are the same and the same voltage and electric field are applied thereto, the vibration d₃₃ in the vertical direction and the vibration d31 in the plane direction (or horizontal direction) of the first vibration layer 211 and the second vibration layer 212 may be equally changed.

For example, the thicknesses T3 and T4 of the first vibration layer 211 and the second vibration layer 212 adjacent to the vibration member 110 among the first to third vibration layers 211 to 213 may be smaller than the thickness T5 of the third vibration layer 213, but embodiments of the present disclosure are not limited thereto. For example, the sum ‘T3+T4’ of the thickness T3 of the first vibration layer 211 and the thickness T4 of the second vibration layer 212 may be 50% or less than the thickness T5 of the third vibration layer 213, but embodiments of the present disclosure are not limited thereto. According to another embodiment of the present disclosure, when the thickness of the vibration member 110 is 600 μm, each of the respective thickness T3 and T4 of the first vibration layer 211 and the second vibration layer 212 may be in a range of 140 μm to 160 μm, and the thickness T5 of the third vibration layer 213 may be in a range of 750 μm to 800 μm. However, embodiments of the present disclosure are not necessarily limited thereto.

According to another embodiment of the present disclosure, the same voltage may be applied to the first vibration layer 211 to the third vibration layer 213, but embodiments of the present disclosure are not limited thereto. In the vibration apparatus 200 according to another embodiment of the present disclosure, each of the respective thicknesses T3 and T4 of the first vibration layer 211 and the second vibration layer 212 may be smaller than the thickness T5 of the third vibration layer 213, and the same voltage may be applied to each of the first vibration layer 211 to the third vibration layer 213, but embodiments of the present disclosure are not limited thereto.

Accordingly, the device 10 according to another embodiment of the present disclosure may supply a higher electric field to the first vibration layer 211 and the second vibration layer 212 adjacent to the vibration member 110 with the same power consumption. For example, when the same driving voltage of 10V (volt) is applied to each of the first vibration layer 211 to the third vibration layer 213, the electric field of the first vibration layer 211 may be about 0.667 k V/cm, the electric field of the second vibration layer 212 may be about 0.667 k V/cm, and the electric field of the third vibration layer 213 may be about 0.128 kV/cm, but embodiments of the present disclosure are not limited thereto. For example, as the value of the electric field applied to the vibration layer increases, the vibration apparatus 200 may have a larger amplitude displacement.

Accordingly, since the amplitude displacement of the first vibration layer 211 and the second vibration layer 212 adjacent to the vibration member 110 is greater than that of the third vibration layer 213, the vibration apparatus 200 according to another embodiment of the present disclosure may have improved sound pressure characteristics by increasing the amplitude displacement of the vibration apparatus 200.

According to another embodiment of the present disclosure, the vibration apparatus 200 may further include a plurality of electrode layers 250. The plurality of electrode layers 250 may include first to fourth electrode layers 251, 252, 253, and 254.

The first electrode layer 251 may be electrically connected to the first surface (or lower surface) of the first vibration layer 211. The first electrode layer 251 may be configured between the first surface (or lower surface) of the first vibration layer 211 and the vibration member 110. The first electrode layer 251 may be electrically connected to the first signal line 510 of a vibration driving circuit 500. The first electrode layer 251 may be displaced (or vibrated) by the first vibration driving signal V1 applied from the first signal line 510.

The second electrode layer 252 may be formed between the second surface (or upper surface) of the first vibration layer 211 and the first surface (or lower surface) of the second vibration layer 212. The second electrode layer 252 may be electrically connected to the second surface (or upper surface) of the first vibration layer 211 opposite to the first surface (or lower surface) of the first vibration layer 211 and the first surface (or lower surface) of the second vibration layer 212. For example, the second electrode layer 252 may be a common electrode formed between the first vibration layer 211 and the second vibration layer 212. The second electrode layer 252 may be electrically connected to the second signal line 520 of the vibration driving circuit 500. The second electrode layer 252 may be displaced (or vibrated) by the second vibration driving signal V2 applied from the second signal line 520.

The third electrode layer 253 may be formed between the second surface (or upper surface) of the second vibration layer 212 and the first surface (or lower surface) of the third vibration layer 213. The third electrode layer 253 may be electrically connected to the second surface (or upper surface) of the second vibration layer 212 opposite to the first surface (or lower surface) of the second vibration layer 212 and the first surface (or lower surface) of the third vibration layer 213. For example, the third electrode layer 253 may be a common electrode configured between the second vibration layer 212 and the third vibration layer 213. The third electrode layer 253 may be electrically connected to the third signal line 530 of the vibration driving circuit 500. The third electrode layer 253 may be displaced (or vibrated) by the third vibration driving signal V3 applied from the third signal line 530.

The fourth electrode layer 254 may be electrically connected to the second surface (or upper surface) of the third vibration layer 213 opposite to the first surface (or lower surface) of the third vibration layer 213. The fourth electrode layer 254 may be electrically connected to the fourth signal line 540 of the vibration driving circuit 500. The fourth electrode layer 254 may be displaced (or vibrated) by the fourth vibration driving signal V4 applied from the fourth signal line 540.

According to another embodiment of the present disclosure, each of the first to third vibration layers 211, 212, and 213 may be polarized (or polled) by a constant voltage applied to the first to fourth electrode layers 251, 252, 253, and 254 in a constant temperature atmosphere or a temperature atmosphere which is changed from a high temperature to a room temperature.

For example, the first vibration layer 211 may vibrate by alternately repeating contraction and/or expansion due to a reverse piezoelectric effect according to the vibration driving signals V1 and V2 applied to the first electrode layer 251 and the second electrode layer 252. For example, the first vibration layer 211 may vibrate by the vibration d₃₃ in the vertical direction and the vibration d31 in the plane direction (or horizontal direction) by the first electrode layer 251 and the second electrode layer 252. For example, displacement of the vibration apparatus 200 or displacement of the vibration member 110 may be increased by the contraction and expansion in the plane direction of the first vibration layer 211, thereby further improving the vibration characteristics of the vibration apparatus 200 or the vibration member 110.

For example, the second vibration layer 212 may vibrate by alternately repeating contraction and/or expansion due to a reverse piezoelectric effect according to the vibration driving signals V2 and V3 applied to the second electrode layer 252 and the third electrode layer 253. For example, the second vibration layer 212 may vibrate by vibration d₃₃ in the vertical direction and vibration d31 in the plane direction (or horizontal direction) by the second electrode layer 252 and the third electrode layer 253. For example, displacement of the vibration apparatus 200 or displacement of the vibration member 110 may be increased by contraction and expansion in the plane direction of the second vibration layer 212, thereby further improving the vibration characteristics of the vibration apparatus 200 or the vibration member 110.

For example, the third vibration layer 213 may vibrate by alternately repeating contraction and/or expansion due to a reverse piezoelectric effect according to the vibration driving signals V3 and V4 applied to the third electrode layer 253 and the fourth electrode layer 254. For example, the third vibration layer 213 may vibrate by vibration d₃₃ in the vertical direction and vibration d31 in the plane direction (or horizontal direction) by the third electrode layer 253 and the fourth electrode layer 254. For example, displacement of the vibration apparatus 200 or displacement of the vibration member 110 may be increased by contraction and/or expansion in the plane direction of the third vibration layer 213, thereby further improving the vibration characteristics of the vibration apparatus 200 or the vibration member 110.

According to another embodiment of the present disclosure, the first to fourth electrode layers 251, 252, 253, and 254 may have the same size as or a smaller size than the first to third vibration layers 211, 212, and 213, but embodiments of the present disclosure are not limited thereto. The first to fourth electrode layers 251, 252, 253, and 254 according to another embodiment of the present disclosure may be substantially the same as the first to third electrode layers 251, 252, and 253 according to the embodiment of the present disclosure described with reference to FIG. 1.

According to another embodiment of the present disclosure, the device 10 includes the stacked first to third vibration layers 211, 212, and 213, and the plurality of electrode layers 250 so that the volume and thickness of the vibration apparatus 200 may be reduced.

The vibration apparatus 200 according to the embodiment of the present disclosure may further include a cover member 260.

A first cover member 261 may be connected to or coupled to the first surface (or lower surface) of the first electrode layer 251 by the medium of a first adhesive layer 263. The first adhesive layer 263 may be disposed on the first surface (or lower surface) of the vibration part 210. The first adhesive layer 263 may be disposed on the first electrode layer 251. For example, the first adhesive layer 263 may be configured to cover the first electrode layer 251. The first adhesive layer 263 may surround the entire first surface of the first electrode layer 251 and the entire side surface of the first electrode layer 251. The first adhesive layer 263 may surround the entire side surfaces of the second electrode layer 252 and the third electrode layer 253. The first adhesive layer 263 may surround the entire side surfaces of the first vibration layer 211 and the second vibration layer 212. The first adhesive layer 263 may be configured to protect the first surface (or lower surface) of the first vibration layer 211 and the first electrode layer 251. The first adhesive layer 263 may surround a portion of the side surface of the second vibration layer 212. However, embodiments of the present disclosure are not necessarily limited thereto.

The cover member 260 according to another embodiment of the present disclosure may further include a second adhesive layer 264. The second adhesive layer 264 may be disposed on the second surface (or upper surface) of the vibration part 210. The second adhesive layer 264 may be formed on the fourth electrode layer 254. For example, the second adhesive layer 264 may be configured to cover the fourth electrode layer 254. The second adhesive layer 264 may surround the entire second surface of the fourth electrode layer 254 and the entire side surface of the fourth electrode layer 254. The second adhesive layer 264 may be configured to protect the second surface (or upper surface) of the third vibration layer 213 and the fourth electrode layer 254. The second adhesive layer 264 may be configured to surround a portion of the side surface of the third vibration layer 213. However, embodiments of the present disclosure are not necessarily limited thereto.

may further include a second cover member 262, but embodiments of the present disclosure are not limited thereto. The second cover member 262 may be disposed on the second surface (or upper surface) of the third vibration layer 213. The second cover member 262 may be disposed on the second surface (or upper surface) of the fourth electrode layer 254. The second cover member 262 may be formed on the third vibration layer 213 and the fourth electrode layer 254. For example, the second cover member 262 may be configured to cover the third vibration layer 213 and the fourth electrode layer 254. The second cover member 262 may be configured to protect the second surface (or upper surface) of the third vibration layer 213 and the fourth electrode layer 254.

The second cover member 262 may be connected or coupled to the second surface of the third vibration layer 213 or the fourth electrode layer 254 by the medium of a second adhesive layer 264. For example, the second cover member 262 may be connected or coupled to the second surface of the third vibration layer 213 or the fourth electrode layer 254 by a film laminating process using the second adhesive layer 264, but embodiments of the present disclosure are not limited thereto.

According to the embodiment of the present disclosure, the device 10 may further include a vibration driving circuit 500. For example, the vibration driving circuit (or sound processing circuit) may generate the vibration driving signal of AC type including the first to fourth vibration driving signals V1 to V4 based on the sound source. The first vibration driving signal V1 may be any one of a positive (+) vibration driving signal and a negative (−) vibration driving signal, and the second vibration driving signal V2 may be any one of a positive (+) vibration driving signal and a negative (−) vibration driving signal. The third vibration driving signal V3 may be any one of a positive (+) vibration driving signal and a negative (−) vibration driving signal, and the fourth vibration driving signal V4 may be any one of a positive (+) vibration driving signal and a negative (−) vibration driving signal.

The vibration driving circuit 500 according to another embodiment of the present disclosure may include first to fourth signal lines 510, 520, 530, and 540 connected to the first to fourth electrode layers 251, 252, 253, and 254, respectively. According to another embodiment of the present disclosure, the first signal line 510 may be electrically connected to the first electrode layer 251 to supply the first vibration driving signal V1 to the first electrode layer 251. For example, the second signal line 520 may be electrically connected to the second electrode layer 252 to supply signal line 530 may be electrically connected to the third electrode layer 253 to supply the third vibration driving signal V3 to the third electrode layer 253. For example, the fourth signal line 540 may be electrically connected to the fourth electrode layer 254 to supply the fourth vibration driving signal V4 to the fourth electrode layer 254.

According to another embodiment of the present disclosure, the first vibration driving signal V1 and the third vibration driving signal V3 may be the same driving signal, and the second vibration driving signal V2 and the fourth vibration driving signal V4 may be the same driving signal, but embodiments of the present disclosure are not limited thereto. The first vibration driving signal V1 and the second vibration driving signal V2 may be different driving signals, but embodiments of the present disclosure are not limited thereto. The third vibration driving signal V3 and the fourth vibration driving signal V4 may be different driving signals, but embodiments of the present disclosure are not limited thereto. For example, when the first and third vibration driving signals V1 and V3 are positive (+) driving signals, the second and fourth vibration driving signals V2 and V4 may be negative (−) driving signals. However, embodiments of the present disclosure are not necessarily limited thereto. For example, the first vibration layer 211 may be driven by the first vibration driving signal V1 and the second vibration driving signal V2. For example, the second vibration layer 212 may be driven by the second vibration driving signal V2 and the third vibration driving signal V3. For example, the third vibration layer 213 may be driven by the third vibration driving signal V3 and the fourth vibration driving signal V4.

In the device 10 according to the embodiment of the present disclosure, the thicknesses T3 and T4 of the first vibration layer 211 and the second vibration layer 212 adjacent to the vibration member 110 are formed to be thinner than the thickness T5 of the third vibration layer 213, thereby increasing the vibration displacement d31 in the plane direction (or horizontal direction) of the first vibration layer 211 and the second vibration layer 212. Accordingly, it is possible to maximize the amplitude displacement of the vibration apparatus 200 and the vibration member 110.

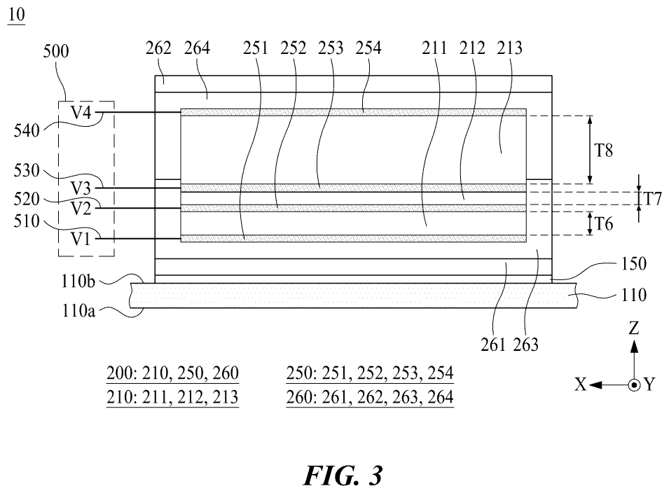

FIG. 3 is a diagram illustrating a device according to another embodiment of the present disclosure. In another embodiment of the present disclosure, thickness of a vibration layer is changed, and the other components except the vibration layer may be substantially the same as those of the embodiment of the present disclosure described with reference to FIG. 2. Accordingly, hereinafter, the same configuration will be briefly described or omitted, and the vibration layer, and configuration related thereto will be described as follows.

Referring to FIG. 3, in a device 10 according to another embodiment of the present disclosure, ‘n’ may be 3. For example, a vibration part 210 may include a first vibration layer 211 to a third vibration layer 213. The remaining components except for the thicknesses of the first vibration layer 211 and the second vibration layer 212 may be substantially the same as those described with reference to FIG. 2.

According to another embodiment of the present disclosure, the respective first vibration layer 211 to the third vibration layer 213 may have different thicknesses, but embodiments of the present disclosure are not limited thereto. The thickness T6 of the first vibration layer 211, the thickness T7 of the second vibration layer 212, and the thickness T8 of the third vibration layer 213 may be different from each other, but embodiments of the present disclosure are not limited thereto. The thickness T6 of the first vibration layer 211 may be greater than the thickness T7 of the second vibration layer 212, but embodiments of the present disclosure are not limited thereto. The thickness T6 of the first vibration layer 211 may be smaller than the thickness T8 of the third vibration layer 213, but embodiments of the present disclosure are not limited thereto. The thickness T7 of the second vibration layer 212 may be smaller than the thickness T6 of the first vibration layer 211, but embodiments of the present disclosure are not limited thereto. The thickness T7 of the second vibration layer 212 may be smaller than the thickness T8 of the third vibration layer 213, but embodiments of the present disclosure are not limited thereto. For example, the sum ‘T6+T7’ of the thickness of the first vibration layer 211 and the thickness of the second vibration layer 212 may be smaller than the thickness T8 of the third vibration layer 213, but embodiments of the present disclosure are not limited thereto. For example, the sum ‘T6+T7’ of the thickness of the first vibration layer 211 and the thickness of the second vibration layer 212 may be the same as the thickness T1 of the first vibration layer 211 described with reference to FIG. 1, but embodiments of the present disclosure are not limited thereto. For example, the thickness T8 of the third vibration layer 213 may be the same as the thickness T2 of the second vibration layer 212 described with reference to FIG. 1, but embodiments of the present disclosure are not limited thereto. For example, the thickness T8 of the third vibration layer 213 may be substantially the same as the thickness T5 of the third vibration layer 213 described with reference to FIG. 2. However, embodiments of the present disclosure are not limited thereto.

According to another embodiment of the present disclosure, since the thickness T6 of the first vibration layer 211 is different from the thickness T8 of the third vibration layer 213, the second vibration layer 212 may be configured to solve the problem that the vibration behaviors of the first vibration layer 211 and the third vibration layer 213 do not match. The second vibration layer 212 may be formed between the first vibration layer 211 and the third vibration layer 213. For example, the first vibration layer 211 may be an active layer, but embodiments of the present disclosure are not limited thereto. For example, the second vibration layer 212 may be an active layer, but embodiments of the present disclosure are not limited thereto. Since a large vibration displacement may not occur in the vibration member 110 having rigidity, the third vibration layer 213 capable of generating sufficient vibration displacement may be formed. For example, the third vibration layer 213 may be a support layer, but embodiments of the present disclosure are not limited thereto.

According to another embodiment of the present disclosure, since the first vibration layer 211 adjacent to the vibration member 110 is configured to be thicker than the second vibration layer 212 and the same electric field is applied thereto, the vibration d31 in the plane direction of the first vibration layer 211 and the second vibration layer 212 may generate the same displacement, and the vibration d₃₃ in the vertical direction of the first vibration layer 211 may increase, thereby further improving vibration efficiency.

For example, the thicknesses T6 and T7 of the first vibration layer 211 and the second vibration layer 212 adjacent to the vibration member 110 among the first vibration layer 211 to the third vibration layer 213 may be smaller than the thickness T8 of the third vibration layer 213, but embodiments of the present disclosure are not limited thereto. For example, the sum ‘T6+T7’ of the thickness of the first vibration layer 211 and the thickness of the second vibration layer 212 may be 50% or less than the thickness T8 of the third vibration layer 213, but embodiments of the present disclosure are not limited thereto. According to another embodiment of the present disclosure, when the thickness of the vibration member 110 is 600 μm, the thickness T6 of the first vibration layer 211 may be in a range of 180 μm to 220 μm, the thickness T7 of the second vibration layer 212 may be in a range of 80 μm to 120 μm, and the thickness T8 of the third vibration layer 213 may be in a range of 750 μm to 800 μm. However, embodiments of the present disclosure are not necessarily limited thereto.

According to another embodiment of the present disclosure, different voltages may be applied to the first vibration layer 211 to the third vibration layer 213, but embodiments of the present disclosure are not limited thereto. In the vibration apparatus 200 according to another embodiment of the present disclosure, the first vibration layer 211 to the third vibration layer 213 may have different thicknesses, and different voltages may be applied to the first vibration layer 211 to the third vibration layer 213, respectively, but embodiments of the present disclosure are not limited thereto.

Accordingly, the device 10 according to another embodiment of the present disclosure may supply a higher electric field to the first vibration layer 211 and the second vibration layer 212 adjacent to the vibration member 110 by applying the different voltages. For example, a driving voltage of about 13.3V may be applied to the first vibration layer 211, a driving voltage of about 6.67V may be applied to the second vibration layer 212, and a driving voltage of 10V may be applied to the third vibration layer 213. In this case, the electric field of the first vibration layer 211 may be about 0.667 k V/cm, the electric field of the second vibration layer 212 may be about 0.667 k V/cm, and the electric field of the third vibration layer 213 may be about 0.128 k V/cm. For example, as the value of the electric field applied to the vibration layer increases, the vibration apparatus 200 may have a larger amplitude displacement.

Accordingly, since the amplitude displacement of the first vibration layer 211 and the second vibration layer 212 adjacent to the vibration member 110 is greater than that of the third vibration layer 213, the vibration apparatus 200 according to another embodiment of the present disclosure may have improved sound pressure characteristics by increasing the amplitude displacement of the vibration apparatus 200.

In the device 10 according to another embodiment of the present disclosure, the thicknesses T6 and T7 of the first vibration layer 211 and the second vibration layer 212 adjacent to the vibration member 110 may be formed to be thinner than the thickness T8 of the third vibration layer 213, and different voltages may be applied to each vibration layer so that it is possible to increase the vibration displacement d31 in the plane direction (or horizontal direction) of the first vibration layer 211 to the third vibration layer 213. In addition, in the device 10 according to another embodiment of the present disclosure, the thickness of the first vibration layer 211 adjacent to the vibration member 110 may be greater than the thickness of the second vibration layer 212, and may be thinner smaller than the thickness of the third vibration layer 213, thereby further increasing the vibration displacement d₃₃ in the vertical direction of the first vibration layer 211 and the second vibration layer 212. Accordingly, it is possible to maximize the amplitude displacement of the vibration apparatus 200 and the vibration member 110.

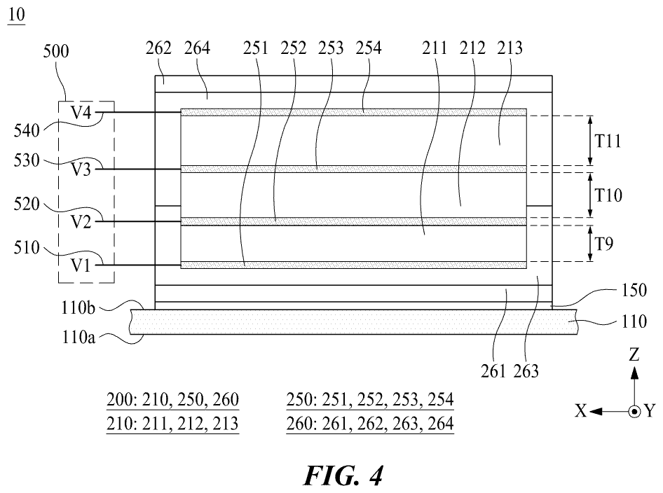

FIG. 4 is a diagram illustrating a device according to another embodiment of the present disclosure. In another embodiment of the present disclosure, the component of a vibration layer is changed, and the other components except the vibration layer may be substantially the same as those of the embodiment of the present disclosure described with reference to FIG. 1. Accordingly, hereinafter, the same configuration will be briefly described or omitted, and the vibration layer, and configuration related thereto will be described as follows.

Referring to FIG. 4, in a device 10 according to another embodiment of the present disclosure, ‘n’ may be 3. For example, a vibration part 210 may include a first vibration layer 211 to a third vibration layer 213. The first vibration layer 211 may be formed between a vibration member 110 and the second vibration layer 212. The second vibration layer 212 may be formed between the first vibration layer 211 and the third vibration layer 213. The third vibration layer 213 may be formed on the second vibration layer 212. The first vibration layer 211 to the third vibration layer 213 may be overlapped or be stacked to be displaced (or driven) in the same direction, but not limited thereto.

According to another embodiment of the present disclosure, the first vibration layer 211 to the third vibration layer 212 may have different thicknesses T9, T10, and T11, but embodiments of the present disclosure are not limited thereto. For example, the thickness T9 of the first vibration layer 211 may be smaller than the thickness T10 of the second vibration layer 212 and the thickness T11 of the third vibration layer 213, but embodiments of the present disclosure are not limited thereto. For example, the thickness T9 of the first vibration layer 211 may be substantially the same as the thickness T1 of the first vibration layer 211 described with reference to FIG. 1, but embodiments of the present disclosure are not limited thereto.

According to another embodiment of the present disclosure, the second vibration layer 212 and the third vibration layer 213 may have different thicknesses, but embodiments of the present disclosure are not limited thereto. The thickness T10 of the second vibration layer 212 may be different from the thickness T11 of the third vibration layer 213, but embodiments of the present disclosure are not limited thereto. The thickness T10 of the second vibration layer 212 may be smaller than the thickness T11 of the third vibration layer 213, but embodiments of the present disclosure are not limited thereto. For example, the thickness T9 of the first vibration layer 211 may be smaller than the sum ‘T10+T1l’ of the thickness of the second vibration layer 212 and the thickness of the third vibration layer 213, but embodiments of the present disclosure are not limited thereto. For example, the sum ‘T10+T11’ of the thickness of the second vibration layer 212 and the thickness of the third vibration layer 213 may be the same as the thickness T2 of the second vibration layer 212 described with reference to FIG. 1. However, embodiments of the present disclosure are not limited thereto.

For example, the thickness T9 of the first vibration layer 211 adjacent to the vibration member 110 among the first vibration layer 211 to the third vibration layer 213 may be smaller than the sum of the thicknesses T10 and T11 of the second vibration layer 212 and the third vibration layer 213, but embodiments of the present disclosure are not limited thereto. For example, the thickness T9 of the first vibration layer 211 may be 50% or less than the sum ‘T10+T11’ of the thicknesses of the second vibration layer 212 and the third vibration layer 213, but embodiments of the present disclosure are not limited thereto. According to another embodiment of the present disclosure, when the thickness of the vibration member 110 is 600 μm, the thickness T9 of the first vibration layer 211 may be in a range of 280 μm to 320 μm, the thickness T10 of the second vibration layer 212 may be in a range of 340 μm to 380 μm, and the thickness T11 of the third vibration layer 213 may be in a range of 400 μm to 440 μm. However, embodiments of the present disclosure are not necessarily limited thereto.

For example, the first vibration layer 211 may be an active layer, but embodiments of the present disclosure are not limited thereto. For example, the second vibration layer 212 may be an active layer, but embodiments of the present disclosure are not limited thereto. Since a large vibration displacement may not occur in the vibration member 110 having rigidity, the third vibration layer 213 capable of generating sufficient vibration displacement may be formed. For example, the third vibration layer 213 may be a support layer, but embodiments of the present disclosure are not limited thereto. According to another embodiment of the present disclosure, the same voltage may be applied to the first vibration layer 211 to the third vibration layer 213, but embodiments of the present disclosure are not limited thereto. In a vibration apparatus 200 according to another embodiment of the present disclosure, the thickness T9 of the first vibration layer 211 may be smaller than the thicknesses T10 and T11 of the second vibration layer 212 and the third vibration layer 213, and the same voltage may be applied to the first vibration layer 211 to the third vibration layer 213, but embodiments of the present disclosure are not limited thereto.

Accordingly, the device 10 according to another embodiment of the present disclosure may supply a higher electric field to the first vibration layer 211 adjacent to the vibration member 110 with the same power consumption. For example, when the driving voltage of 10V is applied to each of the first vibration layer 211 to the third vibration layer 213, the electric field of the first vibration layer 211 may be about 0.333 k V/cm, the electric field of the second vibration layer 212 may be about 0.278 k V/cm, and the electric field of the third vibration layer 213 may be about 0.238 k V/cm.

Accordingly, the vibration apparatus 200 according to another embodiment of the present disclosure has the larger amplitude displacement in the first vibration layer 211 adjacent to the vibration member 110, whereby the vibration apparatus 200 according to another embodiment of the present disclosure may have improved sound pressure characteristics by increasing the amplitude displacement of the vibration apparatus 200.

According to another embodiment of the present disclosure, the device 10 may further include a plurality of electrode layers 250, a cover member 260, and a vibration driving circuit 500. Since the plurality of electrode layers 250, the cover member 260, and the vibration driving circuit 500 are substantially the same as those of FIG. 2 in which the vibration layer 210 is formed of three layers and the electrode layer 250 is formed of four layers, different configurations will be described as follows.

The first cover member 261 according to another embodiment of the present disclosure may be connected to or coupled to the first surface (or lower surface) of the first electrode layer 251 by the medium of a first adhesive layer 263. The first adhesive layer 263 may be disposed on the first surface (or lower surface) of the vibration part 210. The first adhesive layer 263 may be configured to surround the entire first surface of the first electrode layer 251 and the entire side surface of the first electrode layer 251. The first adhesive layer 263 may be configured to surround the entire side surface of the second electrode layer 252. The first adhesive layer 263 may be configured to surround the entire side surface of the first vibration layer 211 and a portion of the side surface of the second vibration layer 212. However, embodiments of the present disclosure are not may further include a second adhesive layer 264. The second adhesive layer 264 may be disposed on the second surface (or upper surface) of the vibration part 210. The second adhesive layer 264 may be configured to surround the entire second surface of the fourth electrode layer 254 and the entire side surface of the fourth electrode layer 254. The second adhesive layer 264 may be configured to surround a portion of the side surface of the second vibration layer 212 and the entire side surface of the third vibration layer 213. However, embodiments of the present disclosure are not necessarily limited thereto.

In the device 10 according to another embodiment of the present disclosure, the thickness T9 of the first vibration layer 211 adjacent to the vibration member 110 is formed to be thinner than the thicknesses T10 and T11 of the second and third vibration layers 212 and 213, thereby increasing the vibration displacement d31 in the plane direction (or horizontal direction) of the first vibration layer 211. Accordingly, it is possible to maximize the amplitude displacement of the vibration apparatus 200 and the vibration member 110.

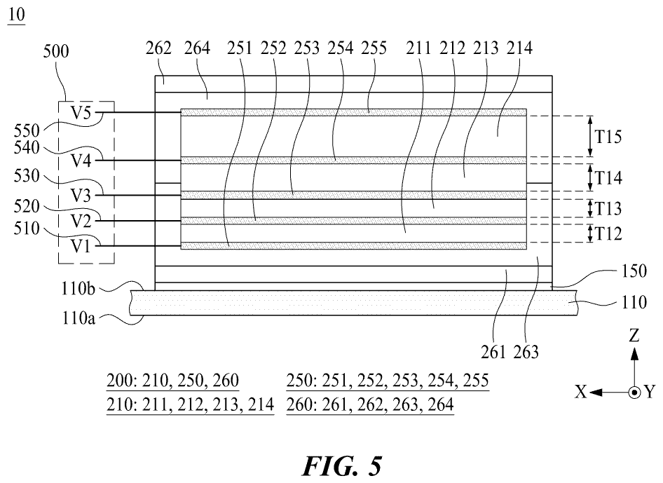

FIG. 5 is a diagram illustrating a device according to another embodiment of the present disclosure. In another embodiment of the present disclosure, the third vibration layer of FIG. 2 includes two layers and the electrode layer includes five layers, and the other components except the vibration layer may be substantially the same as those of the embodiment of the present disclosure described with reference to FIGS. 1 and 2. Accordingly, hereinafter, the same configuration will be briefly described or omitted, and the vibration layer, the electrode layer and configuration related thereto will be described as follows.

Referring to FIG. 5, in a device 10 according to another embodiment of the present disclosure, ‘n’ may be 4. For example, a vibration part 210 may include a first vibration layer 211 to a fourth vibration layer 214. The first vibration layer 211 may be formed between a vibration member 110 and the second vibration layer 212. The second vibration layer 212 may be formed between the first vibration layer 211 and the third vibration layer 213. The third vibration layer 213 may be formed between the second vibration layer 212 and the fourth vibration layer 214. The fourth vibration layer 214 may be formed on the third vibration layer 213. The first to fourth vibration layers 211 to 214 may be overlapped or be stacked to be displaced (or driven) in the same direction, but not limited thereto.

According to another embodiment of the present disclosure, the first vibration layer 211 to the fourth vibration layer 214 may have substantially the same length and width, but not limited thereto. For example, the first to fourth vibration layers 211 to 214 may have substantially the same length and width within an error range of a manufacturing process, but not limited thereto. The lengths and widths of the first vibration layer 211 to the fourth vibration layer 214 may be substantially the same as those of the first vibration layer 211 and the second vibration layer 212 described with reference to FIG. 1.

According to another embodiment of the present disclosure, the first vibration layer 211 and the second vibration layer 212 may have the same thickness, but embodiments of the present disclosure are not limited thereto. For example, the thickness T12 of the first vibration layer 211 and the thickness T13 of the second vibration layer 212 may be the same, but embodiments of the present disclosure are not limited thereto. For example, the sum ‘T12+T13’ of the thickness of the first vibration layer 211 and the thickness of the second vibration layer 212 may be substantially the same as the thickness T1 of the first vibration layer 211 described with reference to FIG. 1. However, embodiments of the present disclosure are not limited thereto. In another example, the first vibration layer 211 and the second vibration layer 212 may have different thicknesses, but embodiments of the present disclosure are not limited thereto. For example, the thickness T12 of the first vibration layer 211 may be different from the thickness T13 of the second vibration layer 212, but embodiments of the present disclosure are not limited thereto. For example, the thickness T12 of the first vibration layer 211 may be greater than the thickness T13 of the second vibration layer 212, but embodiments of the present disclosure are not limited thereto.

According to the embodiment of the present disclosure, the sum ‘T12+T13’ of the thickness T12 of the first vibration layer 211 and the thickness T13 of the second vibration layer 212 may be substantially the same as the thickness T1 of the first vibration layer 211 described with reference to FIG. 1. However, embodiments of the present disclosure are not limited thereto.

According to another embodiment of the present disclosure, the third vibration layer 213 and the fourth vibration layer 214 may have different thicknesses, but embodiments of the present disclosure are not limited thereto. For example, the thickness T14 of the third vibration layer 213 and the thickness T15 of the fourth vibration layer 214 may be different from each other, but embodiments of the present disclosure are not limited thereto. For example, the thickness T14 of the third vibration layer 213 may be smaller than the thickness T15 of the fourth vibration layer 214, but embodiments of the present disclosure are not limited thereto. For example, the sum ‘T14+T15’ of the thickness of the third vibration layer 213 and the thickness of the fourth vibration layer 214 may be substantially the same as the thickness T2 of the second vibration layer 212 described with reference to FIG. 1. However, embodiments of the present disclosure are not limited thereto.

According to another embodiment of the present disclosure, each of the thickness T12 of the first vibration layer 211 and the thickness T13 of the second vibration layer 212 may be smaller than the thickness T14 of the third vibration layer 213, but embodiments of the present disclosure are not limited thereto. For example, the sum ‘T12+T13’ of the thickness T12 of the first vibration layer 211 and the thickness T13 of the second vibration layer 212 may be smaller than the thickness T14 of the third vibration layer 213, but embodiments of the present disclosure are not limited thereto. Each of the thickness T12 of the first vibration layer 211 and the thickness T13 of the second vibration layer 212 may be smaller than the thickness T15 of the fourth vibration layer 214, but embodiments of the present disclosure are not limited thereto. For example, the sum ‘T12+T13’ of the thickness T12 of the first vibration layer 211 and the thickness T13 of the second vibration layer 212 may be smaller than the thickness T15 of the fourth vibration layer 214, but embodiments of the present disclosure are not limited thereto.

For example, the thicknesses ‘T12+T13’ of the first vibration layer 211 and the second vibration layer 212 adjacent to the vibration member 110 among the first vibration layer 211 to the fourth vibration layer 214 may be smaller than the thicknesses ‘T14+T15’ of the third vibration layer 213 and the fourth vibration layer 214, but embodiments of the present disclosure are not limited thereto. For example, the sum ‘T12+T13’ of the thickness T12 of the first vibration layer 211 and the thickness T13 of the second vibration layer 212 may be 50% or less than the sum ‘T14+T15’ of the thickness T14 of the third vibration layer 213 and the thickness T15 of the fourth vibration layer 214, but embodiments of the present disclosure are not limited thereto. According to another embodiment of the present disclosure, when the thickness of the vibration member 110 is 600 μm, each of the thickness T12 and T13 of the first vibration layer 211 and the second vibration layer 212 may be in a range of 140 μm to 160 μm, the thickness T14 of the third vibration layer 213 may be in a range of 340 μm to 380 μm, and the thickness T15 of the fourth vibration layer 214 may be in a range of 400 μm to 440 μm. However, embodiments of the present disclosure are not necessarily limited thereto.

According to another embodiment of the present disclosure, since the thickness T13 of the second vibration layer 212 is different from the thickness T15 of the fourth vibration layer 214, the third vibration layer 213 may be configured to solve the problem that the vibration behaviors of the second vibration layer 212 and the fourth vibration layer 214 do not match. The third vibration layer 213 may be formed between the second vibration layer 212 and the fourth vibration layer 214. For example, the first vibration layer 211 may be an active layer, but embodiments of the present disclosure are not limited thereto. For example, the second vibration layer 212 may be an active layer, but embodiments of the present disclosure are not limited thereto. For example, the third vibration layer 213 may be a buffer layer, but embodiments of the present disclosure are not limited thereto. Since a large vibration displacement may not occur in the vibration member 110 having rigidity, the fourth vibration layer 214 capable of generating sufficient vibration displacement may be formed. For example, the fourth vibration layer 214 may be a support layer, but embodiments of the present disclosure are not limited thereto. According to another embodiment of the present disclosure, the same voltage may be applied to the first vibration layer 211 to the fourth vibration layer 214, but embodiments of the present disclosure are not limited thereto. Accordingly, the device 10 according to another embodiment of the present disclosure may supply a higher electric field to the first vibration layer 211 and the second vibration layer 212 adjacent to the vibration member 110 with the same power consumption. For example, when the driving voltage of 10V is applied to each of the first vibration layer 211 to the fourth vibration layer 214, the electric field of the first vibration layer 211 and the second vibration layer 212 may be about 0.667 k V/cm, the electric field of the third vibration layer 213 may be about 0.278 k V/cm, and the electric field of the fourth vibration layer 214 may be about 0.238 k V/cm. For example, as the value of the electric field applied to the vibration layer increases, the vibration apparatus 200 may have a larger amplitude displacement.

Accordingly, the vibration apparatus 200 according to another embodiment of the present disclosure has the larger amplitude displacement in the first vibration layer 211 and the second vibration layer 212 adjacent to the vibration member 110, whereby the vibration apparatus 200 according to another embodiment of the present disclosure may have improved sound pressure characteristics by increasing the amplitude displacement of the vibration apparatus 200.

According to another embodiment of the present disclosure, the vibration apparatus 200 may further include a plurality of electrode layers 250. The plurality of electrode layers 250 may include first to fifth electrode layers 251, 252, 253, 254, and 255. Since the first to third electrode layers 251, 252, and 253 are substantially the same as the first to third electrode layers 251, 252, and 253 described with reference to FIG. 2, the fourth and fifth electrode layers 254 and 255 will be described below.

The fourth electrode layer 254 may be formed between the second surface (or upper surface) of the third vibration layer 213 and the first surface (or lower surface) of the fourth vibration layer 214. The fourth electrode layer 254 may be electrically connected to the second surface (or upper surface) of the third vibration layer 213 opposite to the first surface (or lower surface) of the third vibration layer 213 and the first surface (or lower surface) of the fourth vibration layer 214. For example, the fourth electrode layer 254 may be a common electrode configured between the third vibration layer 213 and the fourth vibration layer 214. The fourth electrode layer 254 may be electrically connected to the fourth signal line 540 of the vibration driving circuit 500. The fourth electrode layer 254 may be displaced (or vibrated) by the fourth vibration driving signal V4 applied from the fourth signal line 540.

The fifth electrode layer 255 may be electrically connected to the second surface (or upper surface) of the fourth vibration layer 214 opposite to the first surface (or lower surface) of the fourth vibration layer 214. The fifth electrode layer 255 may be electrically connected to the fifth signal line 550 of the vibration driving circuit 500. The fifth electrode layer 255 may be displaced (or vibrated) by the fifth vibration driving signal V5 applied from the fifth signal line 550.

According to another embodiment of the present disclosure, each of the first to fourth vibration layers 211, 212, 213, and 214 may be polarized (or polled) by a constant voltage applied to the first to fifth electrode layers 251, 252, 253, 254, and 255 in a constant temperature atmosphere or a temperature atmosphere which is changed from a high temperature to a room temperature. Since the vibration effect according to the vibration driving signal applied to each of the first to third vibration layers 211, 212, and 213 is substantially the same as the vibration effect according to the vibration driving signal applied to each of the first to third vibration layers 211, 212, and 213 described with reference to FIG. 2, hereinafter, the fourth vibration layer 214 will be described below.

According to the embodiment of the present disclosure, the fourth vibration layer 214 may vibrate by alternately repeating contraction and/or expansion due to a reverse piezoelectric effect according to the vibration driving signals V4 and V5 applied to the fourth electrode layer 254 and the fifth electrode layer 255. For example, the fourth vibration layer 214 may vibrate by the vibration d₃₃ in the vertical direction and the vibration d31 in the plane direction (or horizontal direction) by the fourth electrode layer 254 and the fifth electrode layer 255. For example, the displacement of the vibration apparatus 200 or the displacement of the vibration member 110 may be increased by the contraction and/or expansion in the plane direction of the fourth vibration layer 214, thereby further improving vibration characteristics of the vibration apparatus 200 or the vibration member 110.

According to another embodiment of the present disclosure, the first to fifth electrode layers 251, 252, 253, 254, and 255 may have the same size as or a smaller size than the first to fourth vibration layers 211, 212, 213, and 214, but embodiments of the present disclosure are not limited thereto. The first to fifth electrode layers 251, 252, 253, 254, and 255 according to another embodiment of the present disclosure may be substantially the same as the first to third electrode layers 251, 252, and 253 according to the embodiment of the present disclosure described with reference to FIG. 1.

According to another embodiment of the present disclosure, since the device 10 includes the stacked first to fourth vibration layers 211, 212, 213, and 214 and the plurality of electrode layers 250, the volume and thickness of the vibration apparatus 200 may be reduced.

The vibration apparatus 200 according to the embodiment of the present disclosure may further include a cover member 260. A first cover member 261 may be connected to or coupled to the first surface (or lower surface) of the first electrode layer 251 by the medium of a first adhesive layer 263. The first adhesive layer 263 may be disposed on the first surface (or lower surface) of the vibration part 210. The first adhesive layer 263 may be formed on the first electrode layer 251. For example, the first adhesive layer 263 may be configured to cover the first electrode layer 251. The first adhesive layer 263 may be configured to surround the entire first surface of the first electrode layer 251 and the entire side surface of the first electrode layer 251. The first adhesive layer 263 may be configured to surround the entire side surfaces of the second electrode layer 252 and the third electrode layer 253. The first adhesive layer 263 may be configured to surround the entire side surfaces of the first vibration layer 211 and the second vibration layer 212. The first adhesive layer 263 may be configured to surround a portion of the side surface of the third vibration layer 213. However, embodiments of the present disclosure are not necessarily limited thereto.

may further include a second adhesive layer 264. The second adhesive layer 264 may be disposed on the second surface (or upper surface) of the vibration part 210. The second adhesive layer 264 may be formed on the fifth electrode layer 255. For example, the second adhesive layer 264 may be configured to cover the fifth electrode layer 255. The second adhesive layer 264 may be configured to surround the entire second surface of the fifth electrode layer 255 and the entire side surface of the fifth electrode layer 255. The second adhesive layer 264 may be configured to surround the entire side surface of the fourth electrode layer 254. The second adhesive layer 264 may be configured to surround the entire side surface of the fourth vibration layer 214. The second adhesive layer 264 may be configured to surround a portion of the side surface of the third vibration layer 213. However, embodiments of the present disclosure are not necessarily limited thereto.

The second cover member 262 according to another embodiment of the present disclosure may be disposed on the second surface (or upper surface) of the fourth vibration layer 214. The second cover member 262 may be disposed on the second surface (or upper surface) of the fifth electrode layer 255. The second cover member 262 may be formed on the fourth vibration layer 214 and the fifth electrode layer 255. For example, the second cover member 262 may be configured to cover the fourth vibration layer 214 and the fifth electrode layer 255. The second cover member 262 may be configured to protect the second surface (or upper surface) of the fourth vibration layer 214 and the fifth electrode layer 255.

According to the embodiment of the present disclosure, the device 10 may further include a vibration driving circuit 500. For example, the vibration driving circuit (or sound processing circuit) may generate the vibration driving signal of AC type including the first to fifth vibration driving signals V1 to V5 based on the sound source. The fifth vibration driving signal V5 may be any one of a positive (+) vibration driving signal and a negative (−) vibration driving signal.

The vibration driving circuit 500 according to another embodiment of the present disclosure may include first to fifth signal lines 510, 520, 530, 540, and 550 connected to the first to fifth electrode layers 251, 252, 253, 254, and 255, respectively. For example, the fifth signal line 550 may be electrically connected to the fifth electrode layer 255 to supply the fifth vibration driving signal V5 to the fifth electrode layer 255.

According to another embodiment of the present disclosure, the first vibration driving signal V1, the third vibration driving signal V3, and the fifth vibration driving signal V5 may be the same driving signal, and the second vibration driving signal V2 and the fourth vibration driving signal V4 may be the same driving signal, but embodiments of the present disclosure are not limited thereto. The first vibration driving signal V1 and the second vibration driving signal V2 may be different driving signals, and the third vibration driving signal V3 and the fourth vibration driving signal V4 may be different driving signals, but embodiments of the present disclosure are not limited thereto. The fourth vibration driving signal V4 and the fifth vibration driving signal V5 may be different driving signals, but embodiments of the present disclosure are not limited thereto. For example, when the first vibration driving signal V1, the third vibration driving signal V3, and the fifth vibration driving signal V5 are positive (+) driving signals, the second vibration driving signal V2 and the fourth driving signal V4 may be negative (−) driving signals. However, embodiments of the present disclosure are not necessarily limited thereto. For example, the fourth vibration layer 214 may be driven by the fourth vibration driving signal V4 and the fifth vibration driving signal V5.

In the device 10 according to the embodiment of the present disclosure, the thicknesses T12 and T13 of the first vibration layer 211 and the second vibration layer 212 adjacent to the vibration member 110 are formed to be thinner than the thicknesses T14 and T15 of the third vibration layer 213 and the fourth vibration layer 214, thereby increasing the vibration displacement d₃₃ in the vertical direction and the vibration displacement d31 in the plane direction (or horizontal direction) in the first vibration layer 211 and the second vibration layer 212. Accordingly, it is possible to maximize the amplitude displacement of the vibration apparatus 200 and the vibration member 110.

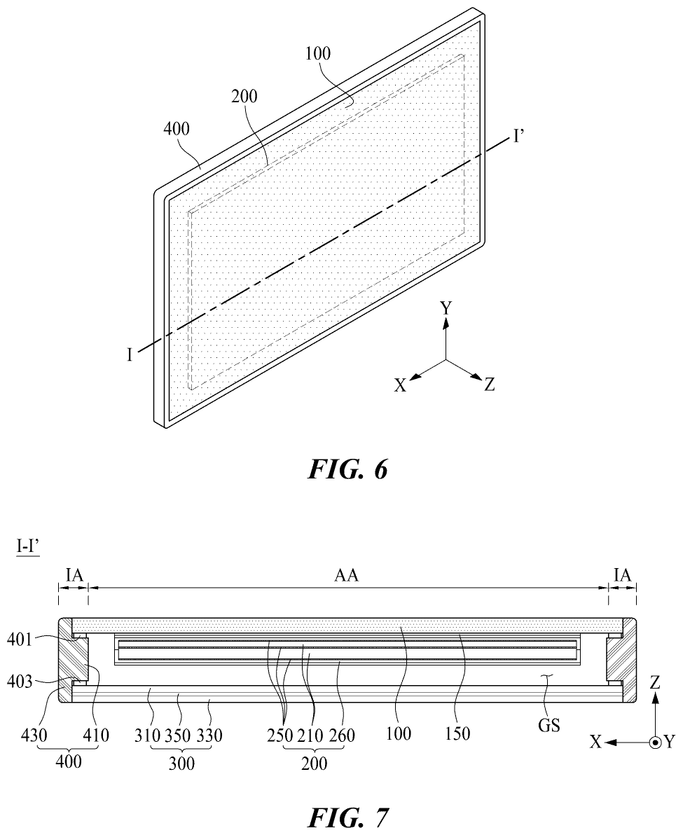

FIG. 6 is a diagram illustrating a device according to another embodiment of the present disclosure. FIG. 7 is a cross-sectional view taken along line I-I′ of FIG. 6. This applies any one of the vibration devices of FIGS. 1 to 5 to the display device, but the embodiments of the present disclosure are not limited thereto.

Referring to FIGS. 6 and 7, a device according to an embodiment of the present disclosure may include a display panel 100 to display an image, and a vibration apparatus 200 to vibrate the display panel 100 on a rear surface (or a backside surface) of the display panel 100. According to another embodiment of the present disclosure, the display panel 100 and the vibration apparatus 200 may be any one of the vibration member and the vibration apparatus described with reference to FIGS. 1 to 5.

The display panel 100 may display an electronic image or a digital image. For example, the display panel 100 may output light to display an image. The display panel 100 may be a curved display panel, or may be any type of display panel, such as a liquid crystal display panel, an organic light-emitting display panel, a quantum dot light-emitting display panel, a micro light-emitting diode display panel, and an electrophoretic display panel. The display panel 100 may be a flexible display panel. For example, the display panel 100 may a flexible light emitting display panel, a flexible electrophoretic display panel, a flexible electro-wetting display panel, a flexible micro light emitting diode display panel, or a flexible quantum dot light emitting display panel, but embodiments of the present disclosure are not limited thereto.

The display panel 100 according to an embodiment of the present disclosure may include a display area AA (or an active area) for displaying an image according to driving of the plurality of pixels. Furthermore, the display panel 100 may further include a non-display area IA (or an inactive area) surrounding fully or at least partly the display area AA, but embodiments of the present disclosure are not limited thereto.

The display panel 100 according to an embodiment of the present disclosure may include an anode electrode, a cathode electrode, and a light emitting device, and may be configured to display an image in a type such as a top emission type, a bottom emission type, or a dual emission type, according to a structure of a pixel array layer including a plurality of pixels. In the top emission type, an image may be displayed by outputting visible light generated from the pixel array layer to the forward region of a base substrate. In the bottom emission type, an image may be displayed by outputting visible light generated from the pixel array layer to the backward region of the base substrate.

The display panel 100 according to an embodiment of the present disclosure may include a pixel array portion disposed at the display area AA of the substrate. The pixel array portion may include a plurality of pixels which display an image based on a signal supplied through the signal lines. The signal lines may include a gate line, a data line and a pixel driving power line, or the like, but embodiments of the present disclosure are not limited thereto.

Each of the plurality of pixels may include a pixel circuit layer including a driving thin film transistor (TFT) provided at the pixel area which is defined by a plurality of gate lines and/or a plurality of data lines, an anode electrode electrically connected to the driving TFT, a light emitting layer formed over the anode electrode, and a cathode electrode electrically connected to the light emitting layer.

The driving TFT may be configured at a transistor region of each pixel area provided at a substrate. The driving TFT may include a gate electrode, a gate insulation layer, a semiconductor layer, a source electrode, and a drain electrode. The semiconductor layer of the driving TFT may include silicon such as amorphous silicon (a-Si), polysilicon (poly-Si), or low temperature poly-Si or may include oxide such as indium-gallium-zinc-oxide (IGZO), but embodiments of the present disclosure are not limited thereto.

The anode electrode (or pixel electrode) may be provided at an opening region provided at each pixel area and may be electrically connected to the driving TFT.

A light emitting device according to an embodiment of the present disclosure may include an organic light emitting device layer formed over an anode electrode. The organic light emitting device layer may be implemented to emit light having the same color (for example, white light) for each pixel, or may be implemented to emit light having a different color (for example, red light, green light, or blue light) for each pixel. A cathode electrode (or a common electrode) may be connected to the organic light emitting device layer provided in each pixel area in common. For example, the organic light emitting device layer may have a stack structure including a single structure or two or more structures including the same color for each pixel. As another embodiment of the present disclosure, the organic light emitting device layer may have a stack structure including two or more structures including two or more different colors for each pixel. The two or more structures including the two or more different colors may be configured with one or more of blue, red, yellow-green, and green or a combination thereof, but embodiments of the present disclosure are not limited thereto. An example of the combination may include blue and red, red and yellow-green, red and green, red/yellow-green/green, or the like, but embodiments of the present disclosure are not limited thereto. Also, regardless of a stack order thereof, the present disclosure may be applied. The stack structure including two or more structures having the same color or two or more different colors may further include a charge generating layer between the two or more structures. The charge generating layer may have a PN junction structure and may include an N-type charge generating layer and a P-type charge generating layer.

According to another embodiment of the present disclosure, the light emitting device may include a micro light emitting diode device electrically connected to each of an anode electrode and a cathode electrode. The micro light emitting diode device may be a light emitting diode implemented as an integrated circuit (IC) or chip type. The micro light emitting diode device may include a first terminal electrically connected to the anode electrode and a second terminal electrically connected to the cathode electrode. The cathode electrode may be connected to the second terminal of the micro light emitting diode device provided in each pixel area in common. As another example, the light emitting device may include a mini light emitting diode device.

An encapsulation part may be formed on the substrate to surround the pixel array portion, thereby preventing oxygen or water from penetrating into the light emitting device layer of the pixel array portion. The encapsulation part according to an embodiment of the present disclosure may be formed in a multi-layer structure where an organic material layer and an inorganic material layer are alternately stacked, but embodiments of the present disclosure are not limited thereto. The inorganic material layer may prevent oxygen or water from penetrating into a layer of the light emitting device in the pixel array portion. The organic material layer may be formed to have a thickness which is relatively thicker than the inorganic material layer, so as to cover particles occurring in a manufacturing process. For example, the encapsulation part may include a first inorganic layer, an organic layer on the first inorganic layer, and a second inorganic layer on the organic layer. The organic layer may be a particle cover layer, but embodiments of the present disclosure are not limited thereto. The touch panel may be disposed on the encapsulation part, or may be disposed at a rear surface of the pixel array portion or in the pixel array portion.

The display panel 100 according to an embodiment of the present disclosure may include a first substrate, a second substrate, and a liquid crystal layer. The first substrate may be an upper substrate or a thin film transistor (TFT) array substrate. For example, the first substrate may include a pixel array (or a display portion or a display area) including a plurality of pixels which are respectively provided in a plurality of pixel areas formed by intersections of a plurality of gate lines and/or a plurality of data lines. Each of the plurality of pixels may include a TFT connected to a gate line and/or a data line, a pixel electrode connected to the TFT, and a common electrode which is provided adjacent to the pixel electrode and is supplied with a common voltage.

The first substrate may further include a pad part provided at a first periphery portion (or a first non-display portion) and a gate driving circuit provided at a second periphery portion (or a second non-display portion).

The pad part may supply a signal, supplied from the outside, to the pixel array portion and/or the gate driving circuit. For example, the pad part may include a plurality of data pads connected to a plurality of data lines through a plurality of data link lines and/or a plurality of gate input pads connected to the gate driving circuit through a gate control signal line. For example, a size of the first substrate may be greater than that of the second substrate, but embodiments of the present disclosure are not limited thereto.

The gate driving circuit may be embedded (or integrated) into a second periphery portion of the first substrate so as to be connected to the plurality of gate lines. For example, the gate driving circuit may be implemented with a shift register including a transistor, which is formed through the same process as the TFT provided at the pixel area. The gate driving circuit according to another embodiment of the present disclosure may be implemented as an integrated circuit (IC) and may be provided at a panel driving circuit, without being embedded into the first substrate.

The second substrate may be a lower substrate or a color filter array substrate. For example, the second substrate may include a pixel pattern (or a pixel defining pattern) including an opening area overlapping with the pixel area formed in the first substrate, and a color filter layer formed at the opening area. The second substrate may have a size which is smaller than that of the first substrate, but embodiments of the present disclosure are not limited thereto. For example, the second substrate may overlap a remaining portion, other than the first periphery portion, of the first substrate. The second substrate may be attached to a remaining portion, other than the first periphery portion, of the first substrate with a liquid crystal layer therebetween using a sealant.

The liquid crystal layer may be disposed between the first substrate and the second substrate. The liquid crystal layer may include a liquid crystal including liquid crystal molecules where an alignment direction thereof is changed based on an electric field generated by the common voltage and a data voltage applied to a pixel electrode for each pixel.

A second polarization member may be attached on a lower surface of the second substrate and may polarize light which is incident from the backlight source and travels to the liquid crystal layer. A first polarization member may be attached on an upper surface of the first substrate and may polarize light which passes through the first substrate and is output to the outside.

The display panel 100 according to an embodiment of the present disclosure may drive the liquid crystal layer based on an electric field which is generated in each pixel by the data voltage and the common voltage applied to each pixel, and thus, may display an image based on light passing through the liquid crystal layer.

In display panel 100 according to another embodiment of the present disclosure, the first substrate may be implemented as the color filter array substrate, and the second substrate may be implemented as the TFT array substrate. For example, the display panel 100 according to another embodiment of the present disclosure may have a type where an upper portion and a lower portion of the display panel 100 according to an embodiment of the present disclosure are reversed therebetween. For example, a pad part of the display panel 100 according to another embodiment of the present disclosure may be covered by a separate mechanism or structure.

The display panel 100 according to an embodiment of the present disclosure may include a bending portion that may be bent or curved to have a curved shape or a certain curvature radius.

The bending portion of the display panel 100 may be in at least one or more of one periphery portion and the other periphery portion of the display panel 100, which are parallel to each other. The one periphery portion and/or the other periphery portion, where the bending portion is implemented, of the display panel 100 may include only the non-display area IA, or may include a periphery portion of the display area AA and the non-display area IA. The display panel 100 including the bending portion implemented by bending of the non-display area IA may have a one-side bezel bending structure or a both-side bezel bending structure. Also, the display panel 100 including the bending portion implemented by bending of the periphery portion of the display area AA and the non-display area IA may have a one-side active bending structure or a both-side active bending structure.

The vibration apparatus 200 may vibrate the display panel 100 at the rear surface of the display panel 100, thereby providing a sound and/or a haptic feedback based on the vibration of the display panel 100 to a user (or a viewer). The vibration apparatus 200 may be implemented at the rear surface of the display panel 100 to directly vibrate the display panel 100.

As an embodiment of the present disclosure, the vibration apparatus 200 may vibrate according to a voice signal synchronized with an image displayed by the display panel 100 to vibrate the display panel 100. As another embodiment of the present disclosure, the vibration apparatus 200 may be disposed on the display panel 100, and may vibrate according to a haptic feedback signal (or a tactile feedback signal) synchronized with a user touch applied to a touch panel (or a touch sensor layer) embedded into the display panel 100 to vibrate the display panel 100. Accordingly, the display panel 100 may vibrate based on a vibration of the vibration apparatus 200 to provide a user (or a viewer) with at least one of sound and a haptic feedback.

The vibration apparatus 200 according to an embodiment of the present disclosure may be implemented to have a size corresponding to the display area AA of the display panel 100. For example, a size of the vibration apparatus 200 may be the same as or smaller than the size of the display area AA. For example, a size of the vibration apparatus 200 may be the same as or approximately same as the display area AA of the display panel 100, and thus, the vibration apparatus 200 may cover a most region of the display panel 100 and a vibration generated by the vibration apparatus 200 may vibrate a whole portion of the display panel 100, and thus, localization of a sound may be high, and satisfaction of a user may be improved. Also, a contact area (or panel coverage) between the display panel 100 and the vibration apparatus 200 may increase, and thus, a vibration region of the display panel 100 may increase, thereby improving a sound of a middle-low-pitched sound band generated based on a vibration of the display panel 100. Also, a vibration apparatus 200 applied to a large-sized display device may vibrate the entire display panel 100 having a large size (or a large area), and thus, localization of a sound based on a vibration of the display panel 100 may be further enhanced, thereby realizing an improved sound effect. Therefore, the vibration apparatus 200 according to an embodiment of the present disclosure may be disposed at the rear surface of the display panel 100 to sufficiently vibrate the display panel 100 in a vertical (or front-to-rear) direction, thereby outputting a desired sound to a forward region in front of the display device.

According to an embodiment of the present disclosure, the vibration apparatus 200 may be implemented as a film type. Since the vibration apparatus 200 may be implemented as a film type, it may have a thickness which is thinner than the display panel 100, and thus, a thickness of the display device may not increase due to the arrangement of the vibration apparatus 200. For example, the vibration apparatus 200 may be referred to as a sound generating module, a sound generating device, a film actuator, a film type piezoelectric composite actuator, a film speaker, a film type piezoelectric speaker, or a film type piezoelectric composite speaker, which uses the display panel 100 as a vibration plate, but embodiments of the present disclosure are not limited thereto. As another embodiment of the present disclosure, the vibration apparatus 200 may not be disposed at the rear surface of the display panel 100 and may be applied to a vibration object instead of the display panel. For example, the vibration object or the vibration member may be one or more of a non-display panel, wood, plastic, glass, cloth, a vehicle interior material, a vehicle glass window, a building indoor ceiling, a building glass window, an aircraft interior material, an aircraft glass window, or the like, but embodiments of the present disclosure are not limited thereto. For example, the non-display panel may be a light emitting diode lighting panel (or device), an organic light emitting lighting panel (or device), or an inorganic light emitting lighting panel (or device), but embodiments of the present disclosure are not limited thereto. In this case, the vibration object may be applied as a vibration plate, and the vibration apparatus 200 may vibrate the vibration object to output a sound.

According to the embodiment of the present disclosure, the vibration apparatus 200 may be one of the vibration apparatuses described with reference to FIGS. 1 to 5. According to the embodiment of the present disclosure, the vibration apparatus 200 is configured to vibrate the display panel 100, and to include the vibration part having the first to n-th (′n′ is a natural number which is equal to 2 or greater than 2) vibration layers overlapping each other, wherein the first to n-th vibration layers may have different thicknesses, but embodiments of the present disclosure are not limited thereto. For example, the thickness of the first vibration layer adjacent to the display panel 100 may be smaller than the thickness of the n-th vibration layer, but embodiments of the present disclosure are not limited thereto.

Accordingly, the device according to the embodiment of the present disclosure may adjust the neutral plane of the display panel 100 and the vibration apparatus 200 so that the device may contract or expand in the same driving direction (or displacement direction) according to the vibration driving signal, thereby increasing or maximizing the displacement amount (or bending force) or the amplitude displacement. Accordingly, the vibration apparatus 200 may increase (or maximize) the displacement amount (or bending force) or the amplitude displacement of the display panel 100, thereby improving the sound characteristics and/or the sound pressure characteristics of the middle-and-low-pitched sound band generated according to the vibration of the display panel 100. For example, the sound characteristics and/or the sound pressure characteristics of the middle low-pitched sound band generated in the display panel 100 may be improved according to the vibration of the vibration apparatus 200. For example, the middle-and-low-pitched sound band may be 200 Hz˜1 Khz, but not limited thereto. For example, the high-pitched sound band may be 1 kHz or more or 3 kHz or more, but not limited thereto.

According to the embodiment of the present disclosure, the vibration part of the vibration apparatus 200 may include first to n-th vibration layers (or piezoelectric structures or piezoelectric vibration layers) including piezoelectric ceramics having piezoelectric characteristics. For example, each of the first to n-th vibration layers may include piezoelectric ceramic having a perovskite crystal structure and may vibrate (or mechanical displacement) in response to the electric signal applied from the outside. For example, when the vibration driving signal (or voice signal) is applied to each of the first to n-th vibration layers, the first to n-th vibration layers may be displaced (or vibrated) in the same direction by the bending phenomenon in which the bending direction is alternately changed according to the alternate repetition of the contraction and expansion due to a reverse piezoelectric effect of the piezoelectric structure (vibration part or piezoelectric vibration part), thereby increasing or maximizing the displacement amount (or bending force) or amplitude displacement of the vibration apparatus 200 and/or the display panel 100.

According to an embodiment of the present disclosure, the device may further include a connection member 150 disposed between the display panel 100 and the vibration apparatus 200.

The connection member 150 may be disposed between the display panel 100 and the vibration apparatus 200, and thus, may connect or couple the vibration apparatus 200 to the rear surface of the display panel 100. For example, the vibration apparatus 200 may be connected or coupled to the rear surface of the display panel 100 by the connection member 150, and thus, may be supported by or disposed at the rear surface of the display panel 100.

According to an embodiment of the present disclosure, the connection member 150 may include a material including an adhesive layer which is good in adhesive force or attaching force with respect to the rear surface of the display panel 100 and the vibration apparatus 200. For example, the connection member 150 may include a foam pad, a double-sided tape, or an adhesive, but embodiments of the present disclosure are not limited thereto. For example, the adhesive layer of the connection member 150 may include epoxy, acryl, silicone, or urethane, but embodiments of the present disclosure are not limited thereto. For example, the adhesive layer of the connection member 150 may differ from the adhesive layer of the adhesive member. For example, the adhesive layer of the connection member 150 may include an acrylic-based material which is relatively better in adhesive force and hardness, compared to urethane. Accordingly, a vibration of the vibration apparatus 200 may be transferred to the display panel 100 well.

The adhesive layer of the connection member 150 may further include an additive, such as a tackifier or an adhesion enhancing agent, a wax component, an anti-oxidation agent, or the like. The additive may prevent the connection member 150 from being detached (stripped) from the display panel 100 by a vibration of the vibration apparatus 200. For example, the tackifier may be rosin derivative or the like, and the wax component may be paraffin wax or the like. For example, the anti-oxidation agent may be a phenol-based anti-oxidation agent, such as thioester, but embodiments of the present disclosure are not limited thereto.

According to another embodiment of the present disclosure, the connection member 150 may further include a hollow portion between the display panel 100 and the vibration apparatus 200. The hollow portion of the connection member 150 may provide an air gap between the display panel 100 and the vibration apparatus 200. Due to the air gap, a sound wave (or a sound pressure) generated based on a vibration of the vibration apparatus 200 may not be dispersed by the connection member 150, and may concentrate on the display panel 100. Thus, the loss of a vibration caused by the connection member 150 may be minimized, thereby increasing a sound pressure characteristic of a sound generated based on a vibration of the display panel 100.

According to an embodiment of the present disclosure, the device may further include a supporting member 300 disposed at a rear surface of the display panel 100.

The supporting member 300 may cover a rear surface of the display panel 100. For example, the supporting member 300 may cover a whole rear surface of the display panel 100 with a gap space GS therebetween. For example, the supporting member 300 may include at least one or more among a glass material, a metal material, and a plastic material. For example, the supporting member 300 may be a rear surface structure or a set structure. For example, the supporting member 300 may be also referred to as a cover bottom, a plate bottom, a back cover, a base frame, a metal frame, a metal chassis, a chassis base, or m-chassis. Therefore, the supporting member 300 may be implemented as an arbitrary type frame or a plate-shaped structure disposed at a rear surface of the display panel 100.

The supporting member 300 according to an embodiment of the present disclosure may include a first supporting member 310 and a second supporting member 330.

The first supporting member 310 may cover a rear surface of the display panel 100. For example, the first supporting member 310 may be a plate-shaped member which covers a whole rear surface of the display panel 100. For example, the first supporting member 310 may be an inner plate which includes at least one or more among a glass material, a metal material, and a plastic material.

The first supporting member 310 may be spaced apart from a rearmost surface of the display panel 100 with a gap space GS therebetween. For example, the gap space GS may be referred to as an air gap, a vibration space, a sound resonance box, or the like, but embodiments of the present disclosure are not limited thereto.

The second supporting member 330 may be disposed at a rear surface of the first supporting member 310. The second supporting member 330 may be a plate-shaped member which covers the whole rear surface of the first supporting member 310. For example, the second supporting member 330 may include at least one or more among a glass material, a metal material, and a plastic material. For example, the second supporting member 330 may be referred to as an outer plate, a rear plate, a back plate, a back cover, or a rear cover, but embodiments of the present disclosure are not limited thereto.

According to an embodiment of the present disclosure, the supporting member 300 may further include a coupling member 350.

The coupling member 350 may be disposed between the first supporting member 310 and the second supporting member 330. For example, the first supporting member 310 and the second supporting member 330 may be coupled or connected to each other by the coupling member 350. For example, the coupling member 350 may be an adhesive resin, a double-sided tape, or a double-sided adhesive foam pad, but embodiments of the present disclosure are not limited thereto. For example, the coupling member 350 may have elasticity for absorbing an impact, but embodiments of the present disclosure are not limited thereto. As an embodiment of the present disclosure, the coupling member 350 may be disposed at a whole region between the first supporting member 310 and the second supporting member 330. As another embodiment of the present disclosure, the coupling member 350 may be provided in a mesh structure including an air gap between the first supporting member 310 and the second supporting member 330.

The device according to an embodiment of the present disclosure may further include a middle frame 400.

The middle frame 400 may be disposed between a rear periphery portion of the display panel 100 and a front periphery portion of the supporting member 300. The middle frame 400 may support at least one or more among the rear periphery portion of the display panel 100 and the front periphery portion of the supporting member 300, and may surround one or more of side surfaces of each of the display panel 100 and the supporting member 300. The middle frame 400 may provide a gap space GS between the display panel 100 and the supporting member 300. The middle frame 400 may be referred to as a middle cabinet, a middle cover, a middle chassis, or the like, but embodiments of the present disclosure are not limited thereto.

According to an embodiment of the present disclosure, the middle frame 400 may include a first supporting portion 410 and a second supporting portion 430.

The first supporting portion 410 may be disposed between the rear periphery portion of the display panel 100 and the front periphery portion of the supporting member 300, and thus, may provide a gap space GS between the display panel 100 and the supporting member 300. A front surface of the first supporting portion 410 may be coupled or connected to the rear periphery portion of the display panel 100 by a first frame connection member 401. A rear surface of the first supporting portion 410 may be coupled or connected to the front periphery portion of the supporting member 300 by a second frame connection member 403. For example, the first supporting portion 410 may have a single frame structure having a square shape or a frame structure having a plurality of divided bar shapes.

The second supporting portion 430 may be vertically coupled to an outer surface of the first supporting portion 410 in parallel with a thickness direction Z of the device. The second supporting portion 430 may surround one or more among an outer surface of the display panel 100 and an outer surface of the supporting member 300, thereby protecting the outer surface of each of the display panel 100 and the supporting member 300. The first supporting portion 410 may protrude from an inner surface of the second supporting portion 430 toward the gap space GS between the display panel 100 and the support member 300.

The device according to an embodiment of the present disclosure may include a panel connection member instead of the middle frame 400.

The panel connection member may be disposed between the rear periphery portion of the display panel 100 and the front periphery portion of the supporting member 300 and may provide the gap space GS between the display panel 100 and the supporting member 300. The panel connection member may be disposed between the rear periphery portion of the display panel 100 and the front periphery portion of the supporting member 300 to adhere the display panel 100 and the support member 300. For example, the panel connection member may be a double-sided tape, a single-sided tape, or a double-sided adhesive foam pad, but embodiments of the present disclosure are not limited thereto. For example, the panel connection member may include epoxy, acryl, silicone, or urethane, but embodiments of the present disclosure are not limited thereto. For example, an adhesive layer of the panel connection member may include a urethane-based material which relatively has a ductile characteristic compared to acryl among acrylic and urethane. Accordingly, a vibration of the display panel 100 transmitted to the support member 300 may be minimized.

In the device according to an embodiment of the present disclosure, when the device includes a panel connection member instead of a middle frame 400, the supporting member 300 may include a bending sidewall which is bent from an end (or an end portion) of the second supporting member 330 and surrounds an outer surface (or an outer sidewall) of each of the first supporting member 310, the panel connection member, and the display panel 100. The bending sidewall according to an embodiment of the present disclosure may have a single sidewall structure or a hemming structure. The hemming structure may be a structure where end portions of an arbitrary member are bent in a curve shape and overlap each other or are apart from each other in parallel. For example, in order to enhance a sense of beauty in design, the bending sidewall may include a first bending sidewall, bent from one side of the second supporting member 330, and a second bending sidewall bent from the first bending sidewall to a region between the first bending sidewall and an outer surface of the display panel 100. The second bending sidewall may be apart from an inner surface of the first bending sidewall. Therefore, the second bending sidewall may prevent the outer surface of the display panel 100 from contacting an inner surface of the first bending sidewall or may prevent a lateral-direction external impact from being transferred to the outer surface of the display panel 100.

A device according to example embodiments of the present disclosure are described below.

A device according to one or more embodiments of the present disclosure may comprise a vibration member, and a vibration apparatus configured to vibrate the vibration member. The vibration apparatus may include a vibration part having first to n-th vibration layers overlapping each other, wherein ‘n’ is a natural number greater than or equal to 2, and the first to n-th vibration layers may have different thicknesses.

According to one or more embodiments of the present disclosure, the thickness of the first vibration layer may be smaller than the thickness of the n-th vibration layer.

According to one or more embodiments of the present disclosure, ‘n’ may be 2, the first vibration layer may be provided between the vibration member and a second vibration layer, and the thickness of the first vibration layer may be smaller than the thickness of the second vibration layer.

According to one or more embodiments of the present disclosure, a voltage applied to the first vibration layer may be the same as a voltage applied to the second vibration layer.

According to one or more embodiments of the present disclosure, the vibration apparatus may further include a first electrode layer electrically connected to a first surface of the first vibration layer, a second electrode layer electrically connected to a second surface of the first vibration layer opposite to the first surface of the first vibration layer and a first surface of the second vibration layer, and a third electrode layer electrically connected to a second surface of the second vibration layer opposite to the first surface of the second vibration layer.

According to one or more embodiments of the present disclosure, ‘n’ may be 3, the first vibration layer may be between the vibration member and a second vibration layer, the second vibration layer may be between the first vibration layer and a third vibration layer, and the thickness of the first vibration layer may be smaller than the thickness of the third vibration layer.

According to one or more embodiments of the present disclosure, the thickness of the first vibration layer may be the same as the thickness of the second vibration layer.

According to one or more embodiments of the present disclosure, the same voltage may be applied to each of the first vibration layer to the third vibration layer.

According to one or more embodiments of the present disclosure, the vibration apparatus may further include a first electrode layer electrically connected to a first surface of the first vibration layer, a second electrode layer electrically connected to a second surface of the first vibration layer opposite to the first surface of the first vibration layer and a first surface of the second vibration layer, a third electrode layer electrically connected to a second surface of the second vibration layer opposite to the first surface of the second vibration layer and a first surface of the third vibration layer, and a fourth electrode layer electrically connected to a second surface of the third vibration layer opposite to the first surface of the third vibration layer.

According to one or more embodiments of the present disclosure, the thickness of the first vibration layer may be greater than the thickness of the second vibration layer.

According to one or more embodiments of the present disclosure, different voltages may be applied to the respective first to third vibration layers.

According to one or more embodiments of the present disclosure, the vibration apparatus may further include a first electrode layer electrically connected to a first surface of the first vibration layer, a second electrode layer electrically connected to a second surface of the first vibration layer opposite to the first surface of the first vibration layer and a first surface of the second vibration layer, a third electrode layer electrically connected to a second surface of the second vibration layer opposite to the first surface of the second vibration layer and a first surface of the third vibration layer, and a fourth electrode layer electrically connected to a second surface of the third vibration layer opposite to the first surface of the third vibration layer.

According to one or more embodiments of the present disclosure, the thickness of the first vibration layer may be greater than the thickness of the second vibration layer.

According to one or more embodiments of the present disclosure, the thickness of the second vibration layer may be smaller than the thickness of the third vibration layer.

According to one or more embodiments of the present disclosure, the same voltage may be applied to each of the first to third vibration layers.

According to one or more embodiments of the present disclosure, the vibration apparatus may further include a first electrode layer electrically connected to a first surface of the first vibration layer, a second electrode layer electrically connected to a second surface of the first vibration layer opposite to the first surface of the first vibration layer and a first surface of the second vibration layer, a third electrode layer electrically connected to a second surface of the second vibration layer opposite to the first surface of the second vibration layer and a first surface of the third vibration layer, and a fourth electrode layer electrically connected to a second surface of the third vibration layer opposite to the first surface of the third vibration layer.

According to one or more embodiments of the present disclosure, ‘n’ may be 4, the first vibration layer may be between the vibration member and a second vibration layer, the second vibration layer may be between the first vibration layer and a third vibration layer, the third vibration layer may be between the second vibration layer and a fourth vibration layer, and the thickness of the first vibration layer may be smaller than the thickness of the fourth vibration layer.

According to one or more embodiments of the present disclosure, the thickness of the first vibration layer may be the same as the thickness of the second vibration layer.

According to one or more embodiments of the present disclosure, the thickness of the first vibration layer may be greater than the thickness of the second vibration layer.

According to one or more embodiments of the present disclosure, the thickness of the third vibration layer may be smaller than the thickness of the fourth vibration layer.

According to one or more embodiments of the present disclosure, the same voltage may be applied to each of the first to fourth vibration layers.

According to one or more embodiments of the present disclosure, the vibration apparatus can further include a first electrode layer electrically connected to a first surface of the first vibration layer, a second electrode layer electrically connected to a second surface of the first vibration layer opposite to the first surface of the first vibration layer and a first surface of the second vibration layer, a third electrode layer electrically connected to a second surface of the second vibration layer opposite to the first surface of the second vibration layer and a first surface of the third vibration layer, a fourth electrode layer electrically connected to a second surface of the third vibration layer opposite to the first surface of the third vibration layer and a first surface of the fourth vibration layer, and a fifth electrode layer electrically connected to a second surface of the fourth vibration layer opposite to the first surface of the fourth vibration layer.

According to one or more embodiments of the present disclosure, the vibration apparatus can further include a cover member on at least one of a first surface of the vibration part and a second surface of the vibration part opposite to the first surface.

According to one or more embodiments of the present disclosure, the device may further comprise a connection member between the vibration member and the vibration apparatus.

According to one or more embodiments of the present disclosure, the vibration member may include a display panel having a pixel for displaying an image, a screen panel on which an image is projected from a display device, a lighting panel, a signage panel, an interior material of a vehicle, an exterior material of the vehicle, a window of the vehicle, a seat interior material of the vehicle, a ceiling material of the vehicle, an interior material of a building, a window of the building, an interior material of an aircraft, a window of the aircraft, and a mirror.

The device according one or more example embodiments of the present disclosure can be applied to all electronic devices that use a display panel as a sound vibration plate. For example, the device according to one or more example embodiments of the present disclosure can be applied to mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the vibration apparatus according to some example embodiments of the present disclosure can be applied to or included in organic light-emitting lighting devices or inorganic light-emitting lighting devices. When the vibration apparatus of one or more example embodiments of the present disclosure is applied to or included in lighting devices, the vibration apparatus can act as a lighting device and a speaker. In addition, when the vibration apparatus according to some example embodiments of the present disclosure is applied to or included in a mobile device, or the like, the vibration apparatus can be one or more of a speaker, a receiver, and a haptic device, but embodiments of the present disclosure are not limited thereto.

It will be apparent to those skilled in the art that various modifications and variations can be made in the present disclosure without departing from the scope of the disclosures. Thus, it is intended that the present disclosure covers the modifications and variations of this disclosure provided that within the scope of the claims and their equivalents.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device comprising:
a vibration member; and
a vibration apparatus configured to vibrate the vibration member, the vibration apparatus including a vibration part having first to n-th vibration layers overlapping each other,
wherein ‘n’ is a natural number greater than or equal to 2, and
wherein the first to n-th vibration layers have different thicknesses.

2. The device of claim 1, wherein a thickness of the first vibration layer is smaller than a thickness of the n-th vibration layer.

3. The device of claim 1,
wherein ‘n’ is 2,
wherein the first vibration layer is provided between the vibration member and a second vibration layer, and
wherein the thickness of the first vibration layer is smaller than the thickness of the second vibration layer.

4. The device of claim 3, wherein a voltage applied to the first vibration layer is the same as a voltage applied to the second vibration layer.

5. The device of claim 3, wherein the vibration apparatus further includes:
a first electrode layer electrically connected to a first surface of the first vibration layer;
a second electrode layer electrically connected to a second surface of the first vibration layer opposite to the first surface of the first vibration layer and a first surface of the second vibration layer; and
a third electrode layer electrically connected to a second surface of the second vibration layer opposite to the first surface of the second vibration layer.

6. The device of claim 1,
wherein ‘n’ is 3,
wherein the first vibration layer is between the vibration member and a second vibration layer,
wherein the second vibration layer is between the first vibration layer and a third vibration layer, and
wherein a thickness of the first vibration layer is smaller than a thickness of the third vibration layer.

7. The device of claim 6, wherein the thickness of the first vibration layer is the same as the thickness of the second vibration layer.

8. The device of claim 6, wherein the same voltage is applied to each of the first vibration layer to the third vibration layer.

9. The device of claim 6, wherein the vibration apparatus further includes:
a first electrode layer electrically connected to a first surface of the first vibration layer;
a second electrode layer electrically connected to a second surface of the first vibration layer opposite to the first surface of the first vibration layer and a first surface of the second vibration layer;
a third electrode layer electrically connected to a second surface of the second vibration layer opposite to the first surface of the second vibration layer and a first surface of the third vibration layer; and
a fourth electrode layer electrically connected to a second surface of the third vibration layer opposite to the first surface of the third vibration layer.

10. The device of claim 6, wherein the thickness of the first vibration layer is greater than the thickness of the second vibration layer.

11. The device of claim 10, wherein different voltages are applied to the respective first to third vibration layers.

12. The device of claim 10,
wherein the vibration apparatus further includes:
a first electrode layer electrically connected to a first surface of the first vibration layer;
a second electrode layer electrically connected to a second surface of the first vibration layer opposite to the first surface of the first vibration layer and a first surface of the second vibration layer;
a third electrode layer electrically connected to a second surface of the second vibration layer opposite to the first surface of the second vibration layer and a first surface of the third vibration layer; and
a fourth electrode layer electrically connected to a second surface of the third vibration layer opposite to the first surface of the third vibration layer.

13. The device of claim 6, wherein the thickness of the first vibration layer is greater than the thickness of the second vibration layer.

14. The device of claim 13, wherein the thickness of the second vibration layer is smaller than the thickness of the third vibration layer.

15. The device of claim 13, wherein the same voltage is applied to each of the first to third vibration layers.

16. The device of claim 13,
wherein vibration apparatus further includes:
a first electrode layer electrically connected to a first surface of the first vibration layer;
a second electrode layer electrically connected to a second surface of the first vibration layer opposite to the first surface of the first vibration layer and a first surface of the second vibration layer;
a third electrode layer electrically connected to a second surface of the second vibration layer opposite to the first surface of the second vibration layer and a first surface of the third vibration layer; and
a fourth electrode layer electrically connected to a second surface of the third vibration layer opposite to the first surface of the third vibration layer.

17. The device of claim 1,
wherein ‘n’ is 4,
wherein the first vibration layer is between the vibration member and a second vibration layer,
wherein the second vibration layer is between the first vibration layer and a third vibration layer,
wherein the third vibration layer is between the second vibration layer and a fourth vibration layer, and
wherein a thickness of the first vibration layer is smaller than a thickness of the fourth vibration layer.

18. The device of claim 17, wherein the thickness of the first vibration layer is the same as the thickness of the second vibration layer.

19. The device of claim 17, wherein the thickness of the first vibration layer is greater than the thickness of the second vibration layer.

20. The device of claim 17, wherein the thickness of the third vibration layer is smaller than the thickness of the fourth vibration layer.

21. The device of claim 17, wherein the same voltage is applied to each of the first to fourth vibration layers.

22. The device of claim 17,
wherein the vibration apparatus further includes:
a first electrode layer electrically connected to a first surface of the first vibration layer;
a second electrode layer electrically connected to a second surface of the first vibration layer opposite to the first surface of the first vibration layer and a first surface of the second vibration layer;
a third electrode layer electrically connected to a second surface of the second vibration layer opposite to the first surface of the second vibration layer and a first surface of the third vibration layer;
a fourth electrode layer electrically connected to a second surface of the third vibration layer opposite to the first surface of the third vibration layer and a first surface of the fourth vibration layer; and
a fifth electrode layer electrically connected to a second surface of the fourth vibration layer opposite to the first surface of the fourth vibration layer.

23. The device of claim 1,
wherein the vibration apparatus further include a cover member on at least one of a first surface of the vibration part and a second surface of the vibration part opposite to the first surface.

24. The device of claim 1, further comprising a connection member between the vibration member and the vibration apparatus.

25. The device of claim 1,
wherein the vibration member includes a display panel having a pixel for displaying an image, a screen panel on which an image is projected from a display device, a lighting panel, a signage panel, an interior material of a vehicle, an exterior material of the vehicle, a window of the vehicle, a seat interior material of the vehicle, a ceiling material of the vehicle, an interior material of a building, a window of the building, an interior material of an aircraft, a window of the aircraft, and a mirror.
